(19) United States
(12) Patent Application Publication
(10) Pub. No.: US 2017/0220943 A1
(43) Pub. Date: Aug. 3, 2017

(54) SYSTEMS AND METHODS FOR AUTOMATED DATA ANALYSIS AND CUSTOMER RELATIONSHIP MANAGEMENT

(71) Applicant: Mentorica Technology Pte Ltd, Singapore (SG)

(72) Inventors: Joe Duncan, Singapore (SG); Marc Rakotomalala, Singapore (SG)

(21) Appl. No.: 15/515,114

(22) PCT Filed: Sep. 2, 2015
(86) PCT No.: PCT/SG2015/050294

§ 371 Date: Mar. 28, 2017

(30) Foreign Application Priority Data
Sep. 30, 2014 (SG) 10201406215Y

(51) Int. Cl. G06N 5/04; G06Q 30/00; G06N 5/02

(52) U.S. Cl. CPC G06N 5/04; G06N 5/022; G06Q 30/01

(57) ABSTRACT

Disclosed is a computer-implemented method for generating a user interface to a data analysis engine comprising a plurality of analysis tools. The method comprises providing a methods knowledge base comprising rules which map data types and/or analysis goals to analysis tools; an inference engine; and a user interface module. The method further comprises receiving, by the user interface module, input relating to one or more user-defined analysis goals; determining, by the inference engine, one or more required data sets based on the one or more user-defined analysis goals; determining, by the inference engine using the methods knowledge base, one or more recommended analysis tools based on the one or more user-defined analysis goals and the one or more required data sets; and outputting, to the user interface module, a control component for each of the one or more recommended analysis tools, each control component being configured to, on detection of a user input event, execute the respective analysis tool on at least one of the required data sets.

### BACKGROUND

The present invention relates to methods and systems that allow users to conduct commercial data analysis, and to develop predictive analytics without the need for outside consultants and experts, or large in-house database infrastructure. It is particularly, though not exclusively, applicable to the field of analytical Customer Relationship Management (CRM).

During the late 1960s, in an effort to find the right data for decision-making, data collection and simple reports of pre-formatted information were created from data stored in databases.

In the 1980s, data access became prevalent as users began to want information more frequently and in a more individualized manner; as a result, they began making informational requests to the databases.

Later, in the 1990s, users required immediate access to more detailed information that responded to “on the fly” questions. They wanted information to be “just-in-time” to correlate with their production and decision-making processes; users began to write their own queries to extract the information they needed from databases.

More recently, users began to realize the need for more tools and techniques in order to identify and find relationships in data, so that the information obtained is more meaningful for their applications. Additionally, companies are recognizing that they have accumulated large volumes of data and, consequently, that they need new tools to sift through it and meet their informational needs.

Online Analytical Processing (OLAP) is a pervasive response to advanced data analysis and decision support in the business area. OLAP tools mostly answer questions such as “What has been going on?”, and they follow what is in essence a deductive approach—first, a theory about a topic of interest is formed, then the analyst narrows it down to more specific hypotheses that can be tested; a further narrowing down is performed while collecting observations to address the hypotheses. This ultimately leads to the ability to test hypotheses with specific data, and a confirmation (or not) of the original theory.

The drawback of this approach is that it depends on coincidence of choosing the right dimensions for drilling-down to acquire the most valuable information, trends and patterns. In essence, it lacks algorithmic approach and depends on an analyst's insight, coincidence, or even luck for acquiring knowledge from data. And for the best analyst, there is a limitation to the number of attributes he can simultaneously consider in order to learn from the data.

With the increase in data volume, velocity, and variety, data analysis such as OLAP has become insufficient, and other methods for data analysis are needed.

To satisfy this need, a new interdisciplinary field appeared. It encompasses statistical, pattern recognition, and machine learning tools to support the discovery of patterns, trends and rules that lie within the data.

Performing analysis in this framework follows an inductive approach of data analysis—moving from specific observations to broader generalizations and theories; the nature of the data itself can dictate the problem definition and lead to discovery of previously unknown but interesting patterns. This approach allows answering questions such as “what are the characteristics of our best customers?”

In this approach, machine-learning algorithms are applied to extract non-obvious knowledge from data to reduce, or even eliminate, the above-mentioned drawbacks. The methods also extend the possibilities of discovering information, trends and patterns by using richer model representations (e.g. decision rules, decision trees) than standard statistical methods, and are therefore well suited for making the results more comprehensible to non-technically oriented business users.

Retailers should, in theory, be able to improve their businesses by applying the patterns, trends, relationships and correlations that have lain undiscovered within large amounts of data.

However, the successful implementation of these techniques is beyond the reach of small and medium size retailers because of high costs, limited access to information, lack of infrastructure, or lack of expertise reasons.

Large retailers perhaps have the same limitations but may have the benefit to turn to software vendors who, however, propose general, and possibly incomplete, cross-industry tools (such as SEMMA of SAS Institute) with little guidance on how to navigate their maze of tools and approaches. A related methodological issue is that the application of these techniques is considered as a kind of an art in which each analyst may follow his or her own “recipe” or form. This is compounded by the need for coordination across multiple departments, resulting in lack of implementation or, if implemented, unsatisfactory results and project abandonment.

Existing software tools require significant expertise in methods, statistics, and databases. They are rather complex, because they offer a variety of methods and parameters that the user must understand in order to use them effectively. A further disadvantage is that a number of experts in varying fields (e.g. methods, database, statistics, artificial intelligence) need to collaborate effectively to make a project successful. These disadvantages call for a different approach.

Retail is a $17 trillion sector of the global economy. However, margins are thin, resulting in low paid and thinly staffed environments. The effect of e*Commerce and more educated consumers is making the financial outlook for “bricks and mortar” retail worse. Although retailers are being told “to do more with less”, the tools to help them achieve this are not being provided.

Retailers face a number of challenges. Sales staff may be inadequately trained and poorly motivated, the effect of this being exacerbated in some instances by digitally empowered consumers. Managers may be overburdened and lacking the tools to simultaneously manage inventory, watch over staff, and maintain customer experience standards. Product manufacturers receive little, if any, feedback from customers to guide product development. Most new technologies being introduced to retail are directed to the customer, fail to integrate the role of the salesperson, and do not address these challenges.

In some sales and marketing contexts, such as in relation to professional services, it has been known to use computerized systems to implement customer relationship management (CRM) principles. Existing CRM tools are targeted for institutional (“white collar”) salespeople, and may not be suitable for a retail environment, in which there are typically time constraints for data entry, limited text entry capability for the salesperson, no desktop PC, and a physical inventory management requirement which is not encountered in other sales environments.

In view of the above, there remains a need for systems and methods which can provide users (such as retailers) with the ability to access, analyse and derive insights from large data sets, without requiring great computational or statistical sophistication of the user. There is also a need in the retail environment for real-time access to customer, sales and inventory data.

### SUMMARY

Some embodiments of the present disclosure relate to a computer-implemented method for generating a user interface to a data analysis engine comprising a plurality of analysis tools, the method comprising:
providing: a methods knowledge base comprising rules which map data types and/or analysis goals to analysis tools; an inference engine; and a user interface module;
receiving, by the user interface module, input relating to one or more user-defined analysis goals;
determining, by the inference engine, one or more required data sets based on the one or more user-defined analysis goals;
determining, by the inference engine using the methods knowledge base, one or more recommended analysis tools based on the one or more user-defined analysis goals and the one or more required data sets; and
outputting, to the user interface module, a control component for each of the one or more recommended analysis tools, each control component being configured to, on detection of a user input event, execute the respective analysis tool on at least one of the required data sets.

Other embodiments of the present disclosure relate to a system for generating a user interface to a data analysis engine comprising a plurality of analysis tools, the system comprising:
a methods knowledge base comprising rules which map data types and/or analysis goals to analysis tools;
an inference engine; and
a user interface module;
wherein the user interface module is configured to receive input relating to one or more user-defined analysis goals;
wherein the inference engine is configured to:
   determine one or more required data sets based on the one or more user-defined analysis goals; and
   determine, using the methods knowledge base, one or more recommended analysis tools based on the one or more user-defined analysis goals and the one or more required data sets; and
wherein the user interface module is configured to output a control component for each of the one or more recommended analysis tools, each control component being configured to, on detection of a user input event, execute the respective analysis tool on at least one of the required data sets.

Further embodiments of the present disclosure relate to a customer relationships management system for a retail organization, comprising:
a server;
a data store in communication with the server, the data store comprising a plurality of records representing products offered for sale within the retail organization and sales outlets within the retail organization;
a plurality of client devices configured to communicate with the server, the client devices including a plurality of sales force devices and at least one manager device;
wherein the server is configured to:
   receive customer engagement data from the sales force devices, the customer engagement data indicating a product sale event and/or customer feedback on a product; and
   process the customer engagement data to determine one or more of:
inventory status for the product; customer preferences in relation to the product; and predicted customer purchasing behavior.

Yet further embodiments relate to a computer-implemented method for acquiring real-time customer feedback in a retail environment, the method comprising:
retrieving product data indicative of categorised product information from a retail inventory system;
generating, based on the categorised product information, a user interface configured to display user-selectable product categories and products;
for each said product, configuring the user interface to display an electronically fillable feedback form, the electronically fillable feedback form being configured to receive user input relating to a plurality of feedback fields; and
receiving, in the electronically fillable feedback form, user input relating to the plurality of feedback fields to generate structured customer engagement data.

Embodiments of the presently disclosed methods and systems bring scientific and engineering dimensions to automated knowledge extraction and application to business users in the retail sector, with minimal help from various human experts; furthermore, as the area of analytical CRM (for example) represents a dynamic environment with continuous need for repeated analyses, the automation of processes present in a production environment is key to meeting an entity's business objectives. Embodiments focus on business users and other decision makers, enabling them to develop data models via a user-friendly and intuitive GUI, and through a cloud-computing platform. As a result, knowledge extraction and application become more fully integrated in business environments and their decision processes.

### BRIEF DESCRIPTION OF THE DRAWINGS

Embodiments of the invention will now be described, by way of non-limiting example only, with reference to the accompanying drawings in which:

FIG. 1 is a block diagram of a system for constructing a data analysis engine according to embodiments;

FIG. 2 is a block diagram of a process for constructing a data analysis engine;

FIG. 3 is an overview of a process for constructing a data analysis engine;

FIG. 4 is an overview of an analysis tool selection process of the process of FIG. 3;

FIG. 5 is a flow diagram of an example of a process for constructing a data analysis engine;

FIG. 6 is an overview of an embodiment of the process of FIGS. 3 and 4 as applied to analytical customer relationship management (CRM);

FIG. 7 shows a mapping of data source types to CRM dimensions in the process of FIG. 6;

FIG. 8 is a block diagram of a system for acquiring user-specific data for input to an analytical CRM process according to embodiments;

FIG. 9 is a block diagram showing a software stack of a web server of the system of FIG. 8;

FIG. 10 is a block diagram showing a software stack of a client computing device of the system of FIG. 8;

FIG. 11(a)-11(b) and 12(a)-12(c) show screen shots of a software module executed by the client computing device of FIG. 10;

FIG. 13(a)-13(b) show screen shots of a software module executed by another client computing device of the system of FIG. 8; and

FIG. 14 shows a block diagram of a model building process.

### DETAILED DESCRIPTION OF EMBODIMENTS

In general terms, the present invention relates to methods and systems for enabling computationally or statistically unsophisticated users, such as retailers—small, mid-size, large—to conduct commercial data analysis in relation to large data sets, and to develop predictive analytics without recourse to outside expertise or large in-house database infrastructure. Exemplary embodiments relate to the field of analytical Customer Relationship Management (CRM).

Embodiments of the present systems and methods may enable the extraction of useful information from the records stored in repositories, corporate databases, and data warehouses by using a series of pattern recognition technologies and statistical and mathematical techniques to discover the possible rules or relationships that govern the data stored in databases.

Recommendation engines, study of customer behavior, supply chain optimization, quality control, fraud detection, cost reductions are some of the areas in which the systems' tools such as neural networks, genetic algorithms, decision trees, particle swarm optimization, and data visualization can be implemented effectively.

For example, by methodically combining multiple sources of data, structured and unstructured, external and internal, from public sources (e.g. census data, demographic data, income data, weather data, transportation data) with private data (e.g. cell phone roaming data, retailer wifi data, voluntary opt-in shopper data, social network data, loyalty data) and proprietary customer specific data such as internally acquired customer engagement data (discussed below), the systems allow to (i) deliver personalized customer messages to increase in-store visits and purchases, and (ii) provide retailers with localized intelligence to facilitate the making of strategic decisions (e.g. assisting management plan geographic expansion and store lifecycle, supporting designers in creating more marketable products, helping merchandising managers to optimize product allocations and offerings at the local level, allowing forecasting and inventory analysts to get better inventory visibility and optimize distribution network).

In certain embodiments, the conducting of retail data analysis and the development of predictive analytics are made easy for users with low expertise level, via web-based canvas-type user interfaces that guide the user through the methodology and show the workflow in a way that is easy to understand.

Embodiments may use visual interfaces to provide the user with flexibility in data manipulation and processing. To reveal relationships among the data, data and results can be visualized by a variety of graphical representations: plots, scatter diagrams, spider web diagrams, histograms, distribution tables, etc.

Preferably, methods and systems according to embodiments of the invention are implemented via a cloud computing system, thus providing the retailer with the benefit of a large-scale production system for an almost zero upfront infrastructure investment.

An expert system may guide the user through all the steps of the method in order to choose, from a set of recommendations, the best technique for the commercial analysis at hand. This expert system may be adaptive in that its suggestions to a novice user are different from that of an advanced user.

Embodiments of the invention provide a rule-based system that guides the user through all the steps of the method and in choosing the best technique for the data analysis at hand. A rule has the form “IF condition THEN action”. In such a rule-based expert system, the domain knowledge is represented as sets of rules that are checked over a collection of facts or knowledge about the current situation. When the IF section of a rule is satisfied by the facts, the action specified by the THEN section is performed. The IF section of a rule is compared with the facts, and the rules whose IF section matches the facts are executed. This action may modify the set of facts in the knowledge base. The rules may comprise “fuzzy” rules, i.e., rules which generate a probabilistic outcome based on the input facts.

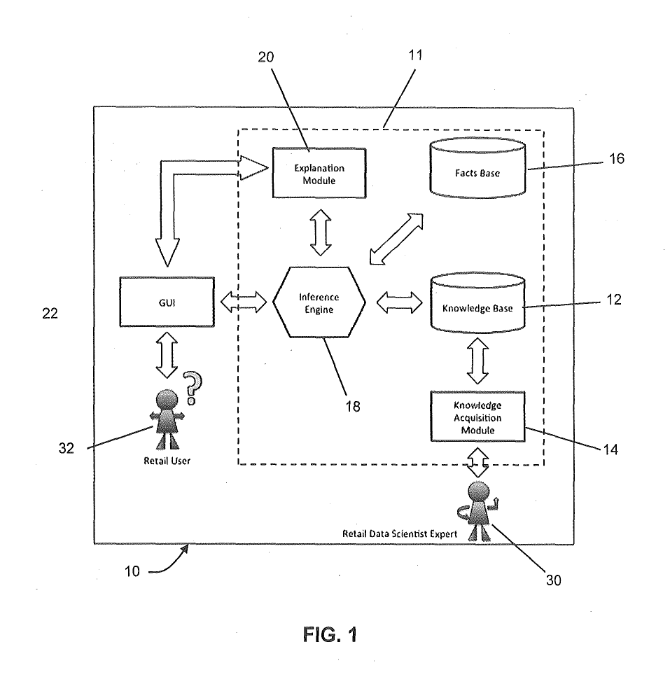

Referring initially to FIG. 1, there is shown a system 10 for constructing a data analysis engine. The system 10 may comprise the following components:
An expert system 11, comprising:
   At least one knowledge base 12 which contains the knowledge of human experts 30 in the field of knowledge discovery, for example as applied to the retail sector;
   A facts base 16 which contains the data to be analysed, as well as the facts resulting from the reasoning made by an inference engine over the knowledge base. The facts base 16 may also contain data relating to a specific entity, for example to an organization such as a retail organization;
   An inference engine 18, a module that performs the transformation from input data to output data. Starting from facts (input data) in the facts base 16, it activates the correspondent knowledge from the knowledge base 12 and builds the reasoning which leads to new facts (output data);
   An explanation module 20 which presents, in an accessible form, the justification of the reasoning made by the inference engine 18;
   A knowledge acquisition module 14 which transforms knowledge of human experts 30 to the appropriate form for use by the inference engine 18; and
A web-based Graphic User Interface (GUI) 22 which allows user access to the expert system 11.

The system 10 may be configured as a simple client-server architecture, with a client device of a user 32 being configured to execute a GUI module 22 to allow the user to interact (via a telecommunications network, such as the Internet, a mobile data communications network, or a local area network) with an expert system 11 which is configured as a single server computing device. The server computing device may store, on a non-volatile storage device, the knowledge base 12 and the facts base 16. The knowledge acquisition module 14, the inference engine 18 and the explanation module 20 may be executable by one or more processors of the server computing device. In preferred embodiments, the system 10 may be implemented as a cloud computing system. A back end server (not shown) may be configured to communicate with GUI module 22 of the client computing device, and to communicate with other back end components via middleware, to manage data processing and communication tasks to be carried out by the other components. Inference engine 18, explanation module 20 and knowledge acquisition module 14 are implemented as back end services, each interacting with the back end server. Data may be accessible by the system 10 via database servers 12 and 16 which may each be in communication with a plurality of storage servers.

The back end components of system 10 collectively define an expert system 11 via which the user 32 can provide input regarding analysis goals (for example, analyses required to fulfil business objectives), receive recommendations as to appropriate data sources and analysis tools for meeting those goals, accept one or more of the recommendations, and execute, via controls provided in user interface 22, one or more of the recommended analysis tools in order to produce summaries, predictions, and/or visualisations based on the data from the recommended data sources and/or from user-defined data sources.

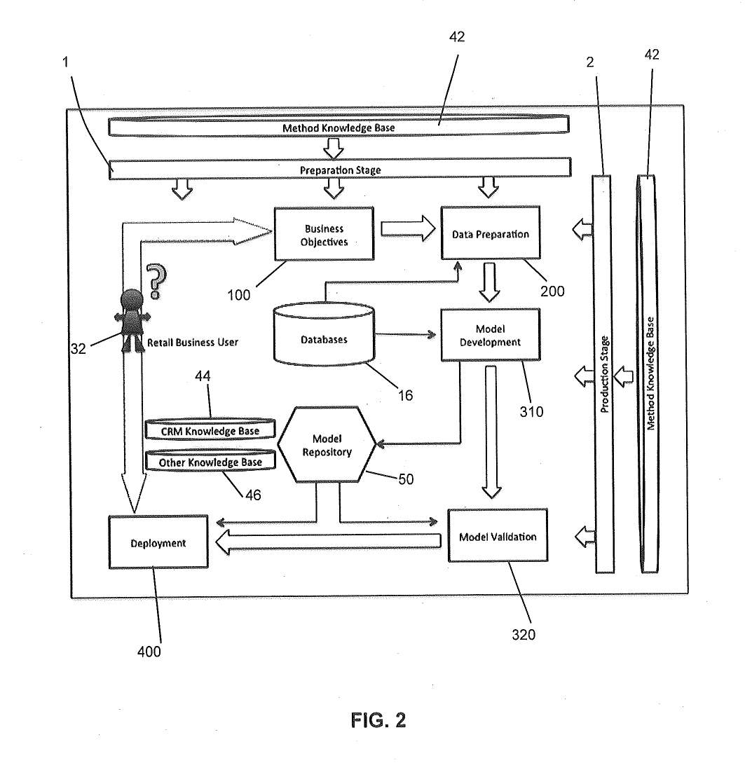

The expert system 11 may comprise a plurality of knowledge bases 12. For example, with reference to FIG. 2, the knowledge bases 12 may comprise (i) a method knowledge base 42, and (ii) a knowledge base 44 specific to a particular topic of interest, such as the retail sector, and in particular examples, analytical CRM.

The knowledge acquisition module 14 may be configured to integrate additional modular knowledge bases 46 to cover other areas relating to the topic of interest, for example additional retail sector fields such as supply chain or logistics.

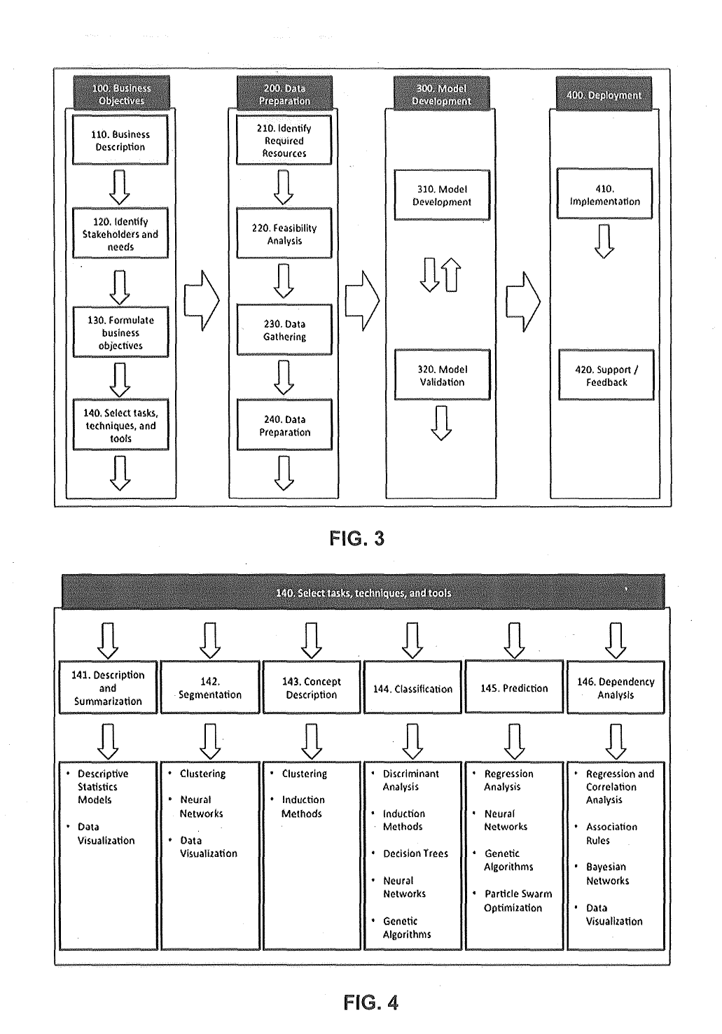

With reference to FIG. 2 and FIG. 3, the process of embodiments of the present invention may comprise two broad stages: (1) a preparation stage, and (2) a production stage. The process may enable the creation of data models and their automated re-calibration based on up-to-date data sets, and allow business users with only a basic level of expertise in knowledge discovery techniques to focus mainly on the deployment phase 400 in order to fully address their business concerns.

Preparation Stage 1

The preparation stage 1 puts an emphasis on the first phases of the method, from business description to model validation. Its main purpose is to confirm the fulfilling of the business objectives and to assure the stability of the data preparation.

To do so, the expert system 11 may generate questions using knowledge base 44, receive answers which can be stored in facts base 16, and provide suggestions (by inference engine 18 using input data from facts base 16 to apply appropriate rules from methods knowledge base 42 and/or CRM knowledge base 44), all via a graphical user interface 22, to guide a business user 32 through a process for generating a data analysis engine. The process may include several iterations, each iteration aiming for a gradual improvement in all phases, and fine-tuning the model.

For example, slight redefinitions of the analysis objectives may have to be made in the initial business description phase 100 according to the results of other phases, especially the results of model validation 320. Or, during the data preparation phase 240, refinements can be made in the automated procedures that recreate data sets for the production stage 2, as periodic updates of the models may be necessary as database contents change. And in the model development 310 and model validation phases 320, an analytical model is created and evaluated on input data from facts base 16, with the aim of fine-tuning the system-selected algorithms by identifying the optimal values of their input parameters. Analytical models generated by model development step 310 and model validation step 320 may be stored in model repository 50.

The business user is presented, via the graphical user interface 22, with the option to accept, or not, the model created with the help of the expert system 11; this determination is made according to whether a model of sufficient quality, with respect to the fulfilling of the business objectives, is delivered.

Production Stage 2

The business user is an active executor of the production stage 2. The production stage 2 provides the business user with updated models for its production environment when data changes, or the business user's strategy, warrant it.

In this stage, the emphasis is on the phases of model development 310, validation 320, and deployment 400; this does not mean that the production stage 2 does not encompass the other phases. Data preparation 240, for example, may be executed automatically based on the procedures developed in the preparation stage 1.

Process Overview

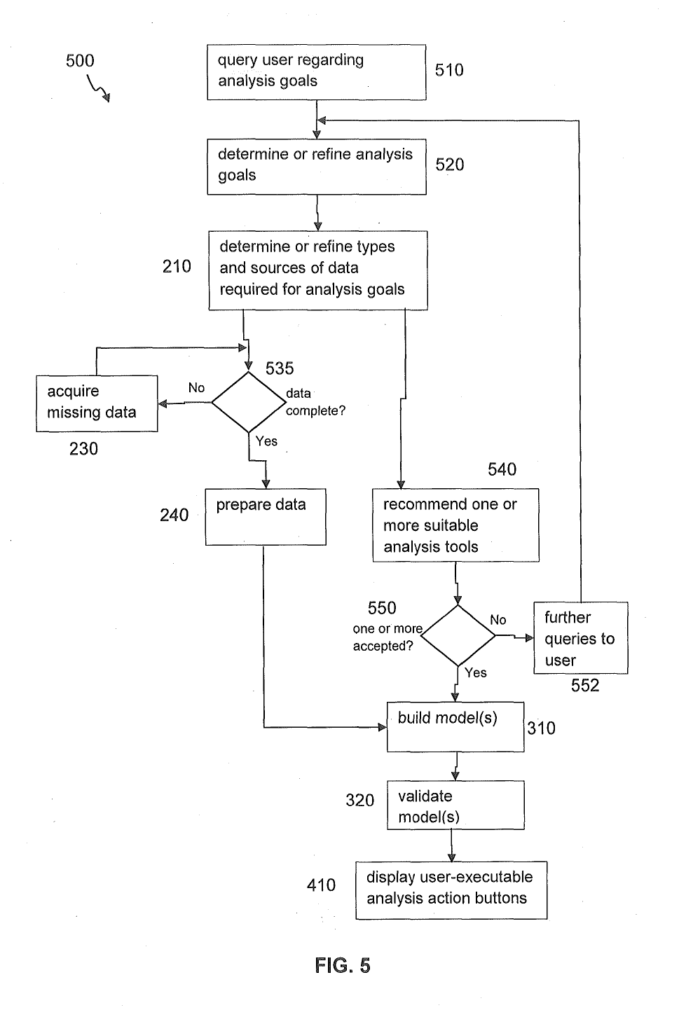

Embodiments of the invention provide a process which comprises stages, implemented partly or wholly by the expert system 11, as schematically represented in FIG. 3 and FIG. 4.

A first series of operations can be categorised under “Business Objectives” 100, which may comprise the following.

A business description stage 110 is aimed at providing the expert system 11 with an understanding of the purpose of the analysis project. When an entity within a retail organization, for example, conducts a project, a study of its goals, objectives, and strategies is required. Failing to do so before implementing the project may cause its results to be incompatible with, or of no use at all to the organization.

Stage 120 involves determination of information in relation to stakeholders affected by the project, and their respective needs. The successful implementation of any information project depends on the direct involvement of the staff and stakeholders, the compromises that they develop for the project, and the satisfactions of their own expectations. If users and stakeholders at the retailer do not believe in the project's results, it is likely that models, patterns, or relationships will not be applied or implemented.

Stage 130 involves determination of information as to the goals and objectives of the project. The analysis goals determined in stage 130 are dynamic as they must account for the changing needs and requirements of the retailer, otherwise, the data, rules, models and relationships structured and defined by the project will face obsolescence.

Stage 140 involves determination of tasks, techniques and tools required to carry out the analysis project. In general, the tasks determined during stage 140 and made available by expert system 11 may be classed as description and summarization 141, segmentation 142, concept description 143, classification 144, prediction 145, and dependency analysis 146.

Description and summarization 141 refers to methods for analysing the data in order to find its most important characteristics. Exemplary techniques applied as part of this task are descriptive statistical models and data visualization (histograms, box plots, scatter plots, etc.).

Segmentation 142 refers to methods for sorting data into a series of different unknown classes or subgroups that share the same characteristics, but that are different from each other. Exemplary techniques for segmentation include clustering, neural networks, and data visualization.

Concept description 143 refers to methods for describing data classes or subgroups, and points out important concepts, characteristics and parts that may facilitate their understanding.

Classification 144 is very similar to segmentation 142, but the major difference is that classification 144 assumes that classes and subgroups are known. Classification 144 encompasses techniques such as discriminant analysis, induction and decision trees, neural networks, and genetic algorithms.

Prediction models 145 try to forecast an unknown value corresponding to a specific class. Prediction models are usually built using techniques such as neural networks, regression analyses, regression trees, and genetic algorithms.

Dependency analysis 146 refers to methods for describing all the significant dependencies among data elements; association and sequential patterns techniques are of particular value to commercial data, for example.

Each of the tasks, techniques and tools 141-146 may encompass a plurality of different methods, as shown in FIG. 4, and each method may be associated in methods knowledge base 42 with one or more rules, and with one or more data types, data sources, and/or analysis goals. Accordingly, the inference engine 18 of expert system 11 can make an initial determination from methods knowledge base 42, at least in part based on user input at stages 110, 120 and 130, of a subset of the methods under 141-146 which fulfils the analysis goals and is therefore available for use in the analysis project.

Following the business objectives operations 100, a second set of operations 200, relating to data preparation, can be carried out by the system 10.

At stage 210 the expert system 11 identifies required resources—software, hardware, data, and personnel—and determines their availability, or not, within the organization, using facts base 16. For the resources that are available, the expert system 11 determines their accessibility, functions, and involvement in the project, as they could otherwise be assigned to other existing projects in execution. The expert system 11 may determine that it already has certain of the necessary software, hardware, and data, and may generate information for the user 32 as to what remaining external resources are required.

At stage 220, feasibility is evaluated along the operational, technical, schedule, and economic dimensions. Operational feasibility analysis determines whether the project can work. Technical feasibility, in contrast, concerns the availability of the technology required to implement the project. The schedule feasibility determines whether the project can be successfully completed within a desirable or required timeframe, if any. Economic feasibility study involves determining whether the benefits generated by the project are sufficiently economically attractive to make implementation worth it.

At stage 230, expert system 11 determines whether data that are required to meet the analysis goals are missing or incomplete, and if so, executes one or more data acquisition processes. Information is a dynamic asset that changes in time. Products, services, operators, customers, suppliers, regulations, etc. are factors that frequently change, and so does the information concerning them. Equally important is considering essential aspects of information such as owners, available formats, cost of retrieval, size, security requirements, and privacy.

At stage 240, the expert system 11 cleans the data in order to correct inaccuracies, remove irregularities, eliminate duplicate data, detect and correct missing values, and check for any possible inconsistencies; valid and insightful models can only be created if the information provided is free of noise factors.

Following definition and/or determination of the business objectives 100 and data preparation 200, the expert system 11 develops and tests one or more statistical models for analysis of the data. At stage 310 models are automatically produced by the expert system 11, or programmed using the rules, patterns, or relationships that are discovered by the expert system 11 based on facts base 16 and knowledge bases 42, 44, 46. The generated models are placed in model repository 50. Some embodiments may not require the creation of a model; in some cases, the output data generated by the data preprocessing 200 may be good enough to be used alone. At stage 320, a model validation process is executed to determine whether the created models in model repository 50 can correctly predict the behavior of the variables represented by the data. To that effect, a validation data set can be created or otherwise obtained, and used to verify whether the predicted values of the model are close enough to the behavior of the data in the validation data set.

Once a model is validated, it can be implemented, in implementation stage 410, according to the goals and objectives initially established for the project during stages 110-140. Stage 410 may also comprise analyzing and interpreting the results generated by the models; in this step, evaluation of the project can also be measured.

The process may also comprise a support phase 420, which can ensure that the model is working appropriately and keeps corresponding with the specifications of the project as determined at stages 110-140. Maintenance operations may be periodically conducted, for example, periodic back-ups of data—full, differential, or incremental.

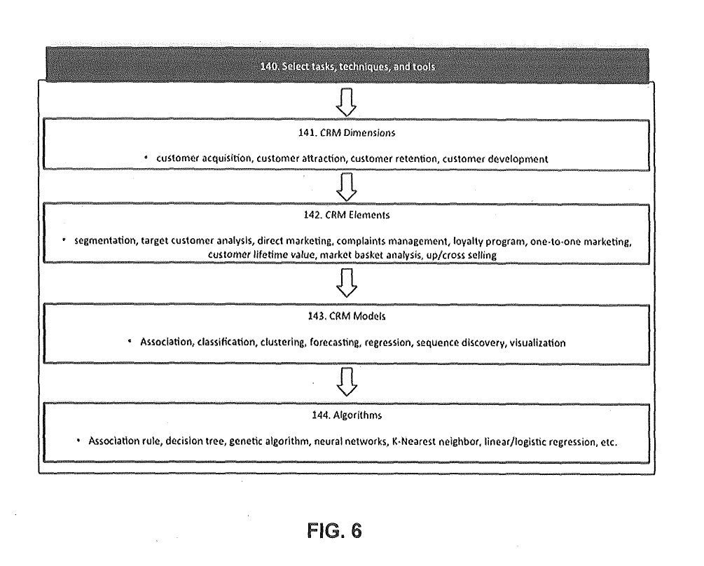

Turning now to FIG. 5, an exemplary process 500 for generating an analysis engine is shown, and the above processes are described in more detail. The process 500 may make use of methods knowledge base 42, and in embodiments, may guide and help the business user to:
1) Quantitatively or quantitatively define a good business objective,
2) Quantitatively guarantee the quality of the data universe,
3) Quantitatively select and prepare the data for the chosen business objective,
4) Quantitatively analyze, segment, and create new factors with greater information value with respect to the business objective,
5) Create a model by choosing the appropriate techniques for the business objective,
6) Quantitatively validate the created model,
7) Measure the precision of the modeling results,
8) Reiterate the modeling phase, especially when the initial results are not the desired or optimum ones,
9) Deploy and apply the created model to real-world production data, and how to evaluate and use the results.

At step 510, the expert system 11 generates a series of queries, which are displayed via user interface 22, to the user 32 regarding the goals of the analyses to be carried out as part of an analysis project. The queries may relate to a business description 110, stakeholders and needs 120, and business objectives 130, as outlined above.

The process 500 may offer different choices to the user 32 as it executes, depending on the level of expertise of user 32 as determined by inference engine 18 via, for example, responses to queries issued by the inference engine 18 through user interface 22, or other interactions between the user 32 and the expert system 11. For example, the expert system 11 may stratify users into Novice, Proficient and Expert categories, and offer different analysis choices dependent on which category a particular user belongs to.

At step 520, based on the responses received by expert system 11 to the queries from step 510, inference engine 18 determines one or more analysis goals. The inference engine 18 may also access facts base 16 or knowledge bases 44, 46 to determine the one or more analysis goals.

In particular, the expert system 11 allows the business user 32 to create a project by using a project creation form generated by the knowledge acquisition module 14 and displayed in user interface 22.

During the Business Objectives phase 100, informative facts about the project are entered and their purpose is mainly to document the motivation for its existence and identify stakeholders' requirements and expectations.

The expert system 11, by inference engine 18 using the information entered in the project creation form, and knowledge base 44, also determines whether the analysis goals are quantitative or qualitative. If an analysis goal can be quantified, the inference engine 18 associates a prediction model with the analysis goal; otherwise a segmentation model is associated with the analysis goal. Relevant rules will be consequently fired during the subsequent model development phase.

Examples of Quantitative Objectives:
Reduce the loss of existing customers by 3 percent, Augment the sales from cross-selling products to existing customers by 5 percent,
Predict, with a precision of 75 percent, which clients are most likely to contract a new product.

Examples of Qualitative Objectives:
Identify new categories of clients and products,
Create new customer segmentation.

The expert system 11 then determines one or more sources and/or types of data required for analyses associated with the one or more analysis goals, for example in accordance with stage 210 discussed above. At step 535, the expert system 11 determines whether all the data required are actually available in facts base 16. If the data are unavailable or incomplete, the expert system 11 executes one or more data acquisition processes 230 as previously mentioned. If all required data are available, data preparation process 240 is executed and the process then proceeds to model building at 310. If the analysis goal has previously been determined to be a qualitative one, then the inference engine 18 will skip model building step 310 and validation step 320, and go straight to deployment step 410.

More particularly, data preparation process 240 may involve the following:

Data Representation

In data analysis, a type is assigned to make it easier to process the data, rather than reflecting the nature of the data; assigning a type to a variable must be done before the data can be explored or modeled.

As the data is acquired and generated by data acquisition processes 230, each variable in the database schema is assigned a default type; the default variable type can be subsequently changed in a data transformation phase if the default assigned format is not deemed the most adequate for the chosen modeling needs.

There are five principal types of variables used in embodiments of the present invention—1) numerical, 2) ordinal categorical, 3) nominal categorical, 4) binary, and 5) date and time—and expert system 11 specifies the allowed operations that can be performed on each type in order to guide the business user and limit errors during the model development phase.

Data Coverage, Quality, Relevance

A significant history of customer engagements, sales transactions, and data may be accumulated after just a few months' worth of execution of data acquisition processes 230. These data acquisition processes 230 may be designed to guarantee data of greater quality with no errors (e.g. via format control), and provide a complete data content.

However, in order to evaluate the viability of the project in terms of the available data, the business user still needs to assess whether a sufficient volume of data has been captured over a required period of time, for all clients, product types, sales channels, etc. with respect to the business objectives. Also, it is necessary to evaluate the quality of the data in terms of reliability. Finally, the grade of relevance of the data with the business objectives must be measured. Ultimately, once data will be selected for the project, the business user will have quantitative a priori information to determine whether sufficient data coverage, quality, and relevance to make the project a success are available.

Expert system 11 quantitatively measures data coverage, quality, and relevance during a data pre-processing stage for each variable (each variable/field of a data table in the data schema):
Coverage, or completeness, of the variable: assigned a value between 0 and 1 by computing the percentage of data items having a value (e.g. 1 indicates total/highest coverage),
The quality of the variable, or the reliability of the current data assigned to the variable: assigned a value between 0 and 1 by estimating the percentage of data items having an erroneous value′ (e.g. 1 indicates the highest quality), ¹ In order to identify and process erroneous data:[Novice, Proficient, and Expert mode] expert system 11 generates a distribution of the values of the variable being studied to establish the general tendency of its values. Then cases that do not have the tendency or order of magnitude of the given variable can be identified. For example, if the expenses for a customer normally varies between $60 and $150, an expense for $2,700 would be suspicious, and automatically flagged erroneous or submitted to the business user for manual crosscheck—an exception to the rule of automatically setting the erroneous flag to TRUE is when the outliers are precisely the data values of interest as a business objective, as it is for example the case in fraud detection or in identifying niche high-profit customers,[Expert mode] expert system 11 uses segmentation models to distinguish clusters (groupings) of normal cases and abnormal cases when some types of erroneous data may be harder to spot.
The relevance of the variable: assigned a value between 0 and 1, where 1 indicates the highest relevance; it is measured by the (absolute value of the) correlation² between the data item and the business objective³. ² For categorical-type variables, the grade of relevance is calculated using the chi-square measure.³ For example, if the business objective were to increase sales from cross-selling products, the correlation would be calculated for each customer variable (age, time as a customer, etc.) with the customer's sales volume.

During this pre-processing stage, procedural steps can be taken by the user to improve data coverage and data quality⁶ depending on the characteristics of the variable being considered: ⁴ The inclusion, or not, of these steps would generate different versions of the project as the model's training datasets are different.
Coverage: various alternatives are available to the user depending on level of expertise:
   [Novice, Proficient, and Expert mode] If the variable is numerical, a statistically simple option is to fill the missing values with the average value of the known values,
   [Proficient and Expert modes] An advanced method is for the expert system 11 to generate a graph of the variable's distribution and identify gaps in the distribution, whose values would be candidates to fill in the missing data values,
   [Expert mode] A sophisticated method is to predict the missing data using a data model whose inputs are the variables that have a high correlation with the variable with the missing values.
Quality: A few alternatives are available to the user:
   Once an error is identified, the value might be manually corrected by finding the data value in the original data source and re-entering it,
   Or, if it is erroneous in the original data, the record may be eliminated altogether; otherwise its values would skew the overall statistics of the dataset.

Expert system 11 makes use of coverage, quality, and relevance in the data selection phase.

Data Transformation

In preferred embodiments, the last step of the data pre-processing stage is to transform variables at the option of the business user⁵. Indeed, a variable default format assigned in the database schema may not be the most adequate for the current needs. ⁵ The inclusion, or not, of these steps would generate different versions of the project as the model's training datasets are different.

Data Type Transformation

Algorithms available in methods knowledge base 42 that model the data typically require all the input variables to have the same type (e.g. numerical).

In order to do so, for a categorical variable, expert system 11 assigns values 1, 2, 3, etc., to each category and from then on the variable is considered numerical; however, this could go against respecting the nature of the variables.

So, another approach available in preferred embodiments is to convert all variables to categories; numerical variables are categorized by defining numerical ranges for a given variable (e.g. via percentiles) and then assigning each record to the appropriate category.

Transforming numerical variables into ordinal categorical variables may also be done for the following reasons: i) the categorical representation of the variables has a higher correlation with the business objective than the original numerical version of the variable does, ii) an ordinal category is easier to associate to the segments of a customer segmentation model, iii) the ordinal type has greater intrinsic information value, iv) the ordinal type can compare directly with other ordinal categorical variables.

Data Range Transformation

In order to compare different datasets, or input them as variables to a predictive model, it is useful to have them in the same range.

To do this, preferred embodiments allow normalization of the data, i.e. configuring the numerical data to fall into the same limits, e.g. from 0 to 1. Data is normalized in order to avoid biasing toward extreme values⁶. To avoid this, both variables are put onto the same scale by normalizing them (normalization also helps the comparing of two or more variables during visualization). ⁶For example, considering a dataset with two variables, “income” and “age”: the income range is from $0 to hundreds of thousands, and the age range is from 18 to 80 years. If these values are input to a data modeling technique, depending on how the technique is implemented, the model might give much more importance to the variable with the largest numerical values.

In practice, expert system 11 guides the business user through the normalization requirements of the modeling technique to be used, or for the reasons for wanting to get the variables onto the same scale.

For example, neural network models require that their input values are normalized, and expert system 11 will automatically perform the transformation if the business user selects the technique. However, in other models, normalization should not be done automatically, as some of the variables characteristics could be lost; for instance, in rule-based models, normalization will make the data more difficult to interpret, and expert system 11 will not automatically perform the transformation in this case. Or, a non-normalized version of the data may be used in part of the analysis phase, and then normalization is performed before inputting to a predictive model.

Data Selection

Instead of using all of the available variables to create models, the business user may select variables and derive new factors (from previously selected variables) in order to obtain a reduced set of the most reliable and relevant variables to the business objective. Also, working with a reduced set of quality inputs will subsequently make the data modeling easier and will result in more precise models.

In order to do so, selecting variables based on their computed quality and relevance to a given business objective is a preliminary filter available as part of data preparation process 240. For example, perhaps only those variables with a minimum relevance and a minimum quality (see above) are considered for inclusion in the set of input variables.

Beyond this simple data filter, the data selection process will be different depending on whether the objective is to develop a segmentation model or a prediction model, as previously determined during business objectives phase 100:
If the business objective is to develop a segmentation model, the variable selection process gives a greater responsibility to the (expert) business user, although expert system 11 provides supporting quantitative tools.
In this scenario, the selection process is data-driven; its starting point is the data, and the expert system 11 supports a guided trial-error approach,
However, if the goal is to develop a prediction model, the variable selection process is heavily statistical and greatly supported by functionalities of the system 11,
In this scenario, the selection process is goal-driven; its starting point is the final result, and expert system 11 supports the reverse-engineering of the desired result.

Data-Driven Variable Selection Process (for Use as Input in a Segmentation Model)

In practice, the user will start with an initial list of input data to be submitted to a segmentation model and, with the help of the expert system 11, he will add/remove/create variables until coherent segments approved by business experts emerge, if any.

To evaluate potential input variables without having the benefit to compare them to an output variable (business objective), expert system 11 provides the business user tools to identify which variables are interrelated; this in turn will give the user clues for possible data analysis.

Correlation (Grade of Relation)
Pearson correlation method for numerical variables, Spearman correlation method for ordinal categories⁷, and a chi-squared test for the correlation of nominal categories. ⁷ As mentioned in [Data type transformation], all numerical variables may have been transformed in ordinal categories.
Expert system 11 systematically computes the correlation (grade of relation) between pairs of input variables in order to identify variables that have a low correlation with other variables in the dataset, for the user to possibly eliminate.

Factorial Analysis
In a large initial number of candidate input variables, the issue is to choose which to include and which to discard. When a set of input variables is known to have mutual correlations, factor analysis can be used in order to find a smaller set of factors that describe the underlying interrelationships and mutual variability; factor analysis allows to define a data model with the minimum number of input variables, each of which provides the maximum informative value with respect to a given business objective. As a result, the complexity of the model is reduced and the quality of the result is further ensured.
Expert system 11 systematically applies the statistical technique of factorial analysis to variables in order to create a reduced number of factors of high predictive value, each factor being a composite of several basic variables.
Principal component analysis (PCA) is a specific technique for factor analysis that generates linear combinations⁸ of variables to maximize the variance between the variables. It successively extracts new factors (linear combinations) that are mutually independent. ⁸ As a result, the value of Factor 1 can for example be (0.352*age value+0.781*profession value −0.419*marital status).

Data Fusion
Expert system 11 allows the creation of fused data. Data fusion is the process of getting less data with more intrinsic information value per data item; for example, two numerical values are unified to form a single variable that best represents a tendency or characteristic⁹. ⁹ For example, consider V1=age and V2=income. From these two variables, V3 is defined as: V3=V1/V2. V3 can be defined given that a significant relationship between V1 and V2 has been established.
Having several variables and not knowing which would be the most appropriate to fuse, expert system 11 employs statistical techniques such as correlations to identify significant relationships between variables.

Goal-Driven Variable Selection Process (for Use as Input in a Prediction Model)

In contrast to the previous case, in this scenario, a business objective is quantitatively defined. The business user's task is therefore to analyze the input data to evaluate the relationship between the input variables and the output variable as the proposed business objective.

From an initial (large) set of input variables, the user's goal is to obtain a minimum subset¹⁰ of those variables that best predict an output variable. To do so: ¹⁰ The minimum subset of variables may include derived factors. For example, if two elemental input variables are age and salary, then a derived factor, ratio_age_salary, could be a ratio of age and salary.

Factorial Analysis and Data Fusion
The above-mentioned tools are also available in this approach, and their outputs (input variables) can be evaluated via their grade of relevance.

Correlation (Grade of Relevance)
The objective is that each input variable has a high correlation¹¹ with what is to be predicted (grade of relevance). ¹¹ The expert system uses the same correlation techniques discussed in the previous scenario to evaluate either grade of relation or relevance.
A typical analysis result performed by expert system 11 is a list of all the input variables ranked by their correlation to the output variable (business outcome). For example, if the business outcome is “buys product A”, the input variables could be “time as customer”, “profession”, “purchased product B”, and “marital status”. A correlation threshold above which the variables are considered relevant can be defined; the business user, for example, could assign this threshold by manually inspecting the distribution of the correlation value and then by identifying an inflection point at which the correlation drops significantly.

Rule Induction
Rule induction is a technique available in expert system 11; it creates “if-then-else”-type rules from a set of input variables and an output variable. It is used to select variables because, as part of its processing, it applies information theory calculations in order to choose the input variables (and their values) that are most relevant to the values of the output variables. Therefore, the least related input variables and values get pruned and disappear from the tree. Once the tree is generated, the variables chosen by the rule induction technique can be noted in the branches and used as a subset for further processing and analysis. The values of the output variable (the outcome of the rule) are in the terminal (leaf) nodes of the tree. The rule induction technique also gives additional information about the values and the variables: the ones higher up in the tree are more general and apply to a wider set of cases, whereas the ones lower down are more specific and apply to fewer cases.
As a result, the tree induction technique is used, in this context, as a filter to identify the variables most and least related to the output variable (e.g. buys product A).

Neural Networks
A neural network is a technique that creates a data model based on the interconnectivity of artificial neurons that become activated or inhibited during the training phase.
In the present context, expert system 11 uses a neural network to rank the relevance of the input variables with respect to an output variable (the business objective). When a neural network is trained, some input neurons (input variables) get assigned a higher weight (activation), whereas other input neurons get assigned a lower weight and are therefore relatively inhibited from contributing to the overall result (output). The weights are a set of numbers that can be displayed, and from this the input variables can be ranked in terms of their activation with respect to the output. Graphing these numbers usually results in an inflection point, where the activation drops considerably. This inflection point can be used as a threshold below which the variables are not relevant to the output (business objective).

Clustering
The technique of clustering implemented in expert system 11 can also be used to select variables. Expert system 11 lets the business user cluster input variables and then overlay an output variable on the resulting two-dimensional cluster plot (the output variable should be categorical, with just a few categories). The way the categories of the output variable fit on the clusters of the input variable can then be seen.

Data Preparation: Sampling, Partitioning, Cross-Validation

Why Sample? Sampling Vs. Partitioning

The expert system 11 guides the business user in the selection of a sufficiently representative subset of data from a complete dataset.

The problem of creating a sample dataset from an entire dataset principally arises when the business objective is to develop a prediction model. Samples must be extracted for specific purposes; typically, two separate samples are needed: one sample of records is used to train the model (the training data), and a second sample is used to test the model that is created with the training data (the test data).

Expert system 11 also gives the user the option to bypass the sampling phase and use instead the entire dataset partitioned in two sets, a training dataset and a test dataset. Indeed, the expert system 11 may give the user access to high-performance computing¹² hardware and software—industrial-grade disc clusters, multi-processors, and algorithms to deal with a whole dataset, in acceptable amounts of time and effort. ¹² The expert system gives access to large-scale computing platforms such as Hive, Pig, and Hadoop, each having their specificities and their strengths. For example, Hadoop is a software system designed for processing Big Data and is based on the MapReduce algorithm, whose original purpose was for indexing the Web. The idea behind Hadoop is that, instead of processing one monolithic block of data with one processor, it fragments the data and processes each fragment in parallel, vastly speeding as a consequence the execution time of a model. DAMS knowledge base makes the choosing of the large-scale computing platform and its technical implementation details transparent to the business user.

However, in practice, when dealing with large datasets, expert system 11 will suggest to the novice and proficient users to, first, possibly get samples of the complete dataset during the model development phase, and then perform an additional model validation with the partitioned entire dataset in order to save computing resources and time during the model development iterative process. Indeed, if the samples give just as good results as the whole dataset, it is common sense, from an economy of effort viewpoint, to use them; that said, expert system 11 may recommend processing the whole dataset if the business objective (analysis goal) entails identifying small niches in the data and avoiding missing outliers.

In any case, independent of whether or not data is sampled for reduction or manageability reasons, distinct train and test datasets still have to be extracted for subsequent model development, and subsets of the data based on different business criteria may be extracted.

How to Sample?

The expert system 11 offers various ways of extracting records, (i) in a random fashion, (ii) by some business criteria, or (iii) to adjust for a class imbalance.

Extraction by Random Sampling

When extracting a random sample, the key consideration is that it must be representative of the entire population. DAMS performs this validation by providing the business user with the distribution of the values of the variables to determine whether they are the same in the complete population of data and in the sample. In effect, there will inevitably be a deviation, but the idea is to minimize it.

In practice, the user has to set an error tolerance margin, say 10 percent, for the observed difference between the statistics of the complete dataset and the statistics of the sampled dataset. For numerical variables, averages and standard deviations are calculated, together with the correlations; for categorical variables, modal values and the difference in the frequencies for each category are calculated.

Extraction by Business Criteria

Expert system 11 allows the user to specify business criteria on which to perform the records extraction—product, region, etc. The user can choose to do the extraction first by the business criteria and then by random sampling of the resulting dataset, or the other way around, first by random sampling of the entire dataset and then by the business criteria.

Extraction to Adjust for Class Imbalance

There is an exception to the rule of keeping the distribution of a variable the same in the sampled dataset with respect to the complete dataset. This is when the variable in question is the output variable (business objective) for a model trained with a so-called supervised learning technique, and there is a skew for that variable that would impair the modeling result. In this situation, expert system 11 allows extracting a sample with a distribution that is different from that of the complete dataset.

Suppose, for example, that from a complete customer dataset, 85 percent are customers who buy product A and 15 percent are customers who buy product B. Also, suppose that 90 percent of all products are of type A and only 10 percent are of type B (i.e there is a skew in the class distribution of the product variable). Finally, assume that the business objective is to predict the customer type who buys product A and to predict the customer type who buys product B, and do this prediction by using a model that needs to be taught customers' buying patterns (this is done by showing the model some customer characteristics as an input and the associated product purchases as an output).

When the model is trained by this so-called supervised learning technique, it may tend to go for obtaining the maximum precision in the easiest manner, which could be by classifying all the customer records as type A. This would indeed give a 100 percent precision for type A records but a 0 percent precision for type B records, which would be useless.

In such situations, expert system 11 allows the user to perform a redistribution in order to increase model precision, by obtaining a sample consisting of 50 percent of each product customer in this two-category output scenario—expert system 11 does this by either replicating records for product B customers until their proportion is equal to 50 percent, or by reducing the number of records for product A customers by further sampling. However, when this is done, expert system 11 prompts the user to recheck the distributions of other input variables with respect to the complete dataset, so as not to introduce secondary biases; indeed, by rebalancing the categories of the variable “product”, the previously balanced categories of another variable, “region”, may become unbalanced.

Sampling for Cross-Validation of the Model

As briefly previously described, at least two datasets have to be extracted for model development—a training dataset and testing dataset.

In generating multiple samples, expert system 11 ensures that all sampled datasets are exclusive, i.e. that the records present in a sample are not present in any other sample.

In practice, expert system 11 will prompt the user to extract multiple files for training and testing in order to obtain a model that generalizes and that has a good average precision for separate datasets of records. In preparing for the model validation phase and the so-called N-fold cross-validation technique, N (N>2) sample datasets are extracted.

Whilst assessing data availability and, if necessary, acquiring any missing data, the expert system 11 also determines, in view of the types and sources of required data and the analysis goals, one or more recommendations for suitable analysis tools selected from tools 141-146 (step 540). The recommendations may be caused to be displayed on graphical user interface 22, which may provide the user 32 with the ability to accept or reject each recommendation, at block 550. If expert system 11 determines that no recommendations have been accepted, it may transmit further queries, at step 552, to the user 32 via graphical user interface 22. The process 500 may return to step 520 and the expert system 11 may use the responses to the further queries may be to refine the previously determined analysis goals, with consequent refinement of the data required sources (again acquiring any required data which may be missing) and analysis tools. Alternative recommendations are again made at block 550. Eventually, if at least one recommendation is accepted, expert system 11 builds and validates at least one model (model building and validation stages 310 and 320 as above).

Using the expert system 11, having defined a good business objective; extracted and prepared relevant data; guaranteed its quality; analyzed, segmented, and created new indicators and factors with greater information value; having tools to produce datasets to develop and validate prediction models, the business user now turns to the task of model development in the expert system 11.

Model Development Process 310

A data model is conceptually simple: it has some input variables, one or more output variables, and it contains an intermediate process that acts on the inputs to produce the output. A model may predict something in the future or cluster many individual records into meaningful groups, such as clients who are most likely to buy a new product, the most profitable clients, etc.

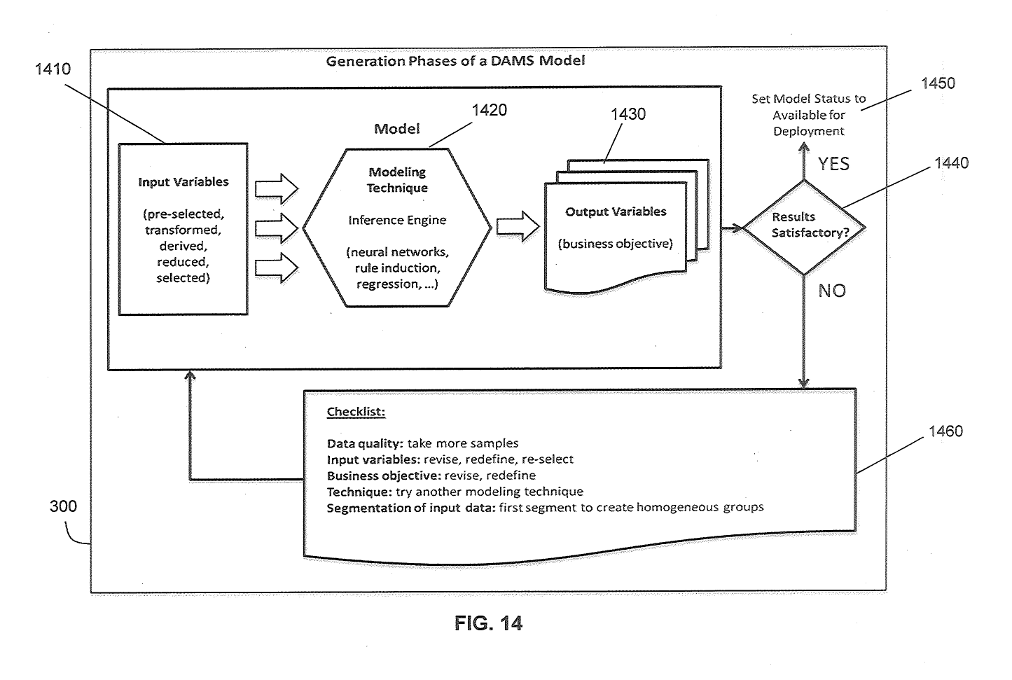

Modeling is a cyclic process, given that failure in this phase can mean that the business user must go back and select new samples or variables, or even redefine the business objectives. FIG. 14 shows the general scheme for this process. Input variables 1410 generated by data preparation process 200 are passed to one or more models 1420 and generate output variables 1430. An assessment is made 1440 as to whether the results of the modelling are satisfactory (step 1440). If so, the expert system 11 sets the status of the current model to “available for deployment” (step 1450).

If the initial results are not the desired or optimum ones, the business user may consult a checklist 1460 which sets out alternative analysis options and could try other modeling techniques and algorithms available to the expert system 11 (via methods knowledge base 42), such as neural, induction, and regression, with the same datasets to find out which one gives the best results.

The technique used also depends on whether the priority is to create profiles (for which the expert system 11 would suggest the most adequate technique in the current context, possibly rule induction), or if predictive precision is the most critical aspect (in which case the expert system 11 would possibly suggest a neural network).

The expert system 11 also makes some considerations with respect to the variable types: some techniques work better for variables that are mainly categorical, and others work better with numerical variables.

It may also be a good strategy for the user to split a hard task in smaller ones if a satisfactory general model cannot be developed, as it is easier to create a predictive model for each major segment of a dataset than to create just a unified model for all the data. That is, use segmentation as a phase prior to creating predictive models: first segment the data (by customer type, product type, etc.) using segmentation algorithms as described herein, and then create distinct models for each of the most important segments; for example, in the case of a customer segmentation of high, medium, and low profitability, a predictive model could be constructed based on the high profitability segment.

Supervised Learning, Unsupervised Learning

A variety of techniques for modeling data, from artificial intelligence approaches, such as neural networks and rule induction, to statistical techniques such as regression are available in the expert system 11. Some are described below. A non-exhaustive list of algorithms appears in Table 1.

Rather than having a deep understanding of the peculiarities of each technique and its implementation in the expert system 11, it is more important for the business user to understand the model development approach and the overarching techniques of supervised learning and unsupervised learning on which the expert system 11 has its foundations.

Supervised Learning

In the technique of supervised learning, the recommended model chosen by the business user via expert system 11 learns to predict or classify data items by being presented with examples and counter-examples. Each example needs data characteristics that allow the model to differentiate between the examples and the counter-examples.

First, the model is trained on some data (the training dataset extracted by the sampling algorithm described above), giving it the true classification for the example and counter-examples. Then, the model is tested on a new dataset of examples and counter-examples (the test dataset extracted by the sampling algorithms), but without supplying the classifier label. The number of correct classifications on the examples and the counter-examples allows for calculating the model's precision. Examples of supervised learning techniques are supervised neural networks and rule/tree induction.

Non-Supervised Learning

In the technique of non-supervised learning, the learning process is not supervised. That is, the classifier label is not given to the model when it is training. The modeling technique chosen by the business user via the expert system 11 has to figure out what the classification is from the input data alone. Unsupervised clustering techniques in general fall into this category, such as the K-means (statistics) and the Kohonen self-organizing map (neural network). By studying the data records assigned to each of the clusters, the business user can then evaluate the criteria that the clustering technique used for grouping. For example, one cluster may contain all the profitable clients and another one may contain only the least profitable clients.

Model Validation 320: Cross-Validation, Continuous Output, Categorical Output

The last step in model development is the model validation and the measuring of its precision.

Model Cross-Validation

A dataset is typically divided into two parts, a dataset for training and a dataset for testing.

If just one training pass and one testing pass are run, there is no guarantee that on other occasions the same model precision will be achieved. Over-fitting can also be another problem, meaning that a model has over-learned a given input data sample, and results in poor precision on the test data. It can also mean that the model's input variables are specialized for a given dataset and do not reflect the more general characteristics of future datasets.

A corrective approach is to perform a cross-validation, i.e. train and test a model on multiple datasets. As a result, the analyst can form an idea of how the created data model generalizes on new datasets as well as ensuring that the model has not learned from a fluke sample.

The expert system 11 automates the cross-validation process. It performs a k-fold cross-validation¹³, in which the dataset is randomly partitioned into k equal-sized subsets. One of the k subsets is designated as the validation set for testing the model, and the remaining k−1 subsets are used as training data. The cross-validation process is then repeated k times, such that each of the k subsets is used once as the validation set. The precision for each of the k tests is then averaged to obtain the overall model precision. ¹³ A typical default value for cross-validation is k=10.

Model Evaluation: Numerical Continuous Output

If the model output is a numerical continuous value, it may be correlated with a known true value. Therefore, the expert system 11 measures the model precision with the correlation between the model output and the true value, with 1 being perfect precision.

Model Evaluation: Categorical Continuous Output

If the model produces a category label as output, the expert system 11 measures the model precision and model recall as the average precision and recall of all the classes.

To do so, first the confusion matrix¹⁴ for all the classes is computed. Each column of the matrix represents the instances in a predicted class, while each row represents the instances in an actual class; as a result, all correct guesses are located in the diagonal of the matrix, so it is easy to visually inspect it for errors, as they will be represented by values outside the diagonal. ¹⁴The matrix name stems from the fact that it makes it easy to see if the system is confusing two classes, i.e. commonly mislabeling one as another.

Then, from the confusion matrix, a confusion table is derived for each class, and it gives for a given class:
the value of the true positives,
the value of the false negatives (i.e. Type 2 errors),
the value of the false positives (i.e. Type 1 errors),
and the value of the true negatives.

This allows a more detailed analysis than the mere proportion of correct guesses (precision). Precision alone is not a reliable metric for the real performance of a classifier, as it will yield misleading results if the input dataset is unbalanced (i.e. when the number of samples in different classes vary greatly); not taking the class imbalance into account could result in poor precision for the model on the training dataset for the minority class, or in a very high precision for the model on the training dataset but poor precision for the minority category on the test dataset. Consequently, in addition to precision, the recall metric is computed in order to predict the “true positives” and “true negatives” with an equally high performance.

Precision for a given class is calculated from the values in the confusion table as:
(true positives) divided by (true positives+false positives), giving a percentage, with 1 being perfect precision.

Similarly, recall for a given class is calculated from the values in the confusion table as:
(true negatives) divided by (true negatives+false negatives), giving a percentage, with 1 being perfect recall.

Finally, the expert system 11 measures the model precision and recall as the average precision and recall of all the classes.

When the model(s) have been generated, and the required data are available, the process 500 provides, via user interface 22, an implementation interface so that the user can execute implementation stage 410 as previously described. The implementation interface allows access by user 32 to the analysis engine generated by process 500. The analysis engine comprises the at least one model generated at step 310, and any other analysis tools identified by the recommendation step 540 of process 500, such as summarisation, segmentation and visualisation tools, as disclosed above.

In particular, the expert system 11 may cause to be displayed on user interface 22 graphical representations of buttons or other control elements which, when clicked, tapped or otherwise suitably interacted with by the user, cause one or more of the tools forming part of the analysis engine to be applied to one or more of the required data sets in order to produce output data in the form of, for example, predictions, classifications, or graphical output.

### Example—Analytical CRM

In one example, the system 10 and process 500 may be applied in the field of Analytical Customer Relationship Management (CRM).

CRM is the strategic use of information, processes, and technology to manage a company's customer relationship across the whole customer life cycle; it comprises a set of processes and enabling systems supporting a business strategy to build long term, profitable relationships with specific customers.

A successful CRM strategy has its foundation on customer data, information technology tools, and, increasingly, the Internet and its associated technologies, such as mobile or social networks. From an architecture point of view, the CRM framework can be classified into operational and analytical. Operational CRM refers to the automation of business processes, whereas analytical CRM refers to the analysis of customer characteristics and behaviors in order to support an organization's customer management strategies.

Many retailers have collected and stored a wealth of data about their current customers, potential customers, suppliers and business partners. However, the inability to discover valuable information hidden in the data prevents them from transforming these data into valuable and useful knowledge.

Within the analytical CRM framework, embodiments of the present invention may generate an Analytical CRM knowledge base and analysis engine which provides these retailers with the appropriate techniques, tools, and expertise to analyze and understand customer behaviors, preferences, and characteristics, and discover the hidden knowledge in large amounts of data in order to make their CRM decisions. As a result, retailers become better at, for example, acquiring and retaining potential customers, or at discriminating and more effectively allocating resources to its most profitable group of customers.

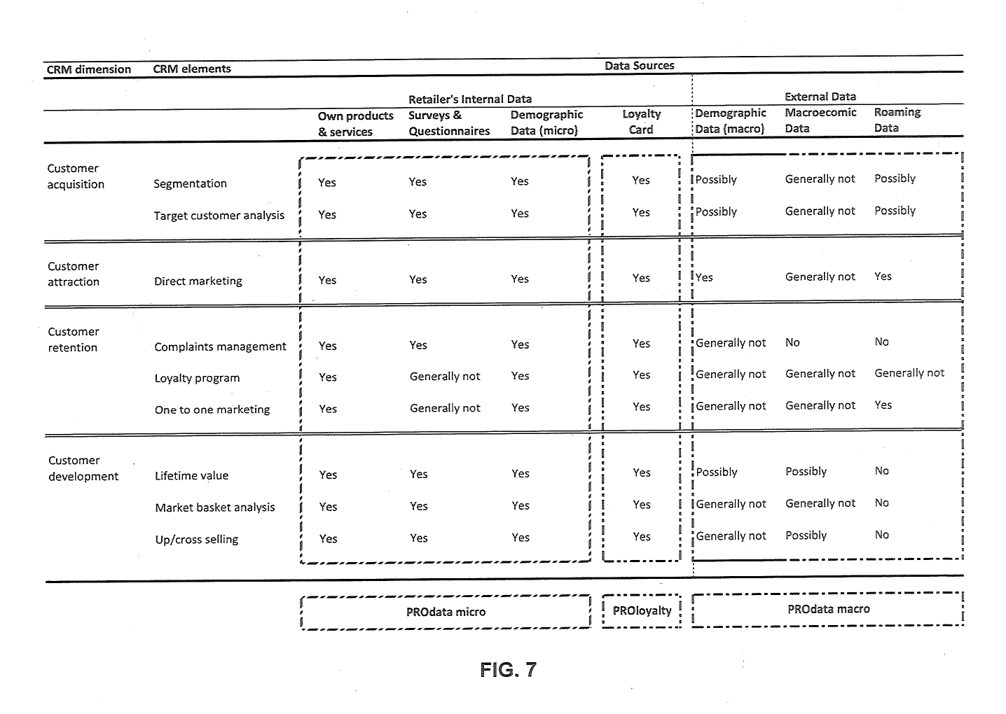

Referring to FIG. 1, FIG. 3 and FIG. 6, after the end of the business objectives phase 100, the expert system 11 determines at step 141 that the project pertains to one of the following four CRM dimensions (analysis goals):

(1) Customer acquisition,

(2) Customer attraction,

(3) Customer retention,

(4) Customer development.

For each CRM dimension, the expert system 11 determines at step 142, by querying the user 32, what kind of CRM element the user 32 wants to address; for example, the elements of customer retention may include one-to-one marketing, loyalty programs and complaints management.

Next, the expert system 11 determines at step 143 what kind of CRM tool is appropriate for the determined CRM dimension and CRM element. Various tools can support CRM elements—for example, association, classification, clustering, forecasting, regression, sequence discovery, and visualization. A combination of elementary tools may be required to support or forecast the effects of a particular CRM strategy; for example, in the case of up/cross selling programs, the expert system 11 can recommend to first segment customers into clusters before an association model is applied to each cluster.

The expert system 11, when applied to the four dimensions of customer acquisition, attraction, retention, and development, creates a deeper understanding of customers in order to maximize their value for the retailer.

(1) Customer Acquisition

In this phase, the retailer targets the population that is most profitable, or is the most likely to become customers, and it also analyzes customers who are being lost to the competition and how they can be won back.

Elements for customer acquisition include target customer analysis and customer segmentation. Target customer analysis involves seeking the profitable segments of customers through analysis of customers' underlying characteristics, whereas customer segmentation involves the partitioning of an entire customer base into smaller homogenous customer groups.

(2) Customer Attraction

After identifying the segments of potential customers, retailers can direct effort and resources into attracting the target customer segments.

The element of customer attraction is direct marketing. Direct marketing is a promotion process, which motivates customers to place orders through various channels. For example, direct email or coupon distributions are typical examples of direct marketing.

(3) Customer Retention

Customer satisfaction refers to the comparison of a customer's expectations with his perception of being satisfied, and is key to CRM as the essential condition to retaining customers.

Elements of customer retention include one-to-one marketing, loyalty programs, and complaints management. One-to-one marketing refers to personalized marketing campaigns that are supported by analyzing, detecting and predicting changes in customer behaviors—customer profiling, recommender systems or replenishment systems are related to one-to-one marketing. Loyalty programs involve campaigns that aim at maintaining a long-term relationship with customers; specifically, churn analysis, credit scoring, and service quality are part of loyalty programs.

(4) Customer Development

Customer development deals with increasing transaction intensity and value, and individual customer profitability.

Elements of customer development include customer lifetime value analysis, up/cross selling, and market basket analysis. Customer lifetime value analysis is defined as the prediction of the total net income a retailer can expect from a customer. Up/Cross selling refers to promotional activities geared towards augmenting the number of closely related products that a customer purchases from a retailer. Market basket analysis aims at maximizing the customer transaction intensity and value by revealing regularities in purchasing behavior.

One example of a set of associations between CRM dimensions, CRM elements, CRM models (or tools) and particular algorithms is set out in Table 1.

TABLE 1
CRM dimensions mapping using CRM knowledge base 44

| CRM dimension => | CRM elements => | CRM model => | Algorithm |
|---|---|---|---|
| Customer acquisition | Segmentation | Classification | Decision tree |
| | | | Self-organizing map, decision tree and Markov chain model |
| | | Clustering | K-means |
| | | | Data envelopment analysis, self organizing map & decision tree |
| | | | Pattern based cluster |
| | | | Self-organizing map |
| | | Regression | Logistic regression |
| | Target customer | Classification | Decision tree |
| | analysis | Clustering | Self-organizing map |
| | | Visualization | Customer map |
| Customer attraction | Direct marketing | Regression | Logistic regression |
| | | Classification | Bayesian network classifier |
| | | | Decision tree |
| | | | Genetic algorithm |
| | | | Neural network |
| | | Clustering | Outlier detection |
| Customer retention | Complaints | Clustering | Self-organizing map |
| | management | Sequence | Survival analysis |
| | | discovery | |
| | Loyalty program | Classification | Decision tree |
| | | | Genetic algorithm |
| | | | Neural network |
| | | | K-nearest neighbor |
| | | | Regression tree |
| | | | Logistic regression |
| | | | Self-organizing map |
| | | | Markov chain |
| | | | Survival analysis |
| | | | Neural network, K-nearest neighbor and decision tree |
| | | | Logistic regression, neural network and random forest |
| | | Clustering | Attribute oriented induction |
| | | Regression | Logistic regression |
| | | Sequence | Goal oriented sequential pattern |
| | | discovery | |
| | One-to-one | Association | Association rules |
| | marketing | | Set theory and self-organizing map |
| | | | Association rules and self-organizing map |
| | | | Association rules and K-means |
| | | Classification | Decision tree |
| | | | Support vector machine |
| | | | Naive Bayes |
| | | | K-nearest network |
| | | | Self-organizing map |
| | | Clustering | Association rules |
| | | | K-nearest neighbor |
| | | | Genetic algorithm |
| | | | Neural network |
| | | | Self-organizing map |
| Customer development | Lifetime value | Classification | Bayesian network classifier |
| | | Clustering | Neural network |
| | | | Survival analysis |
| | | Forecasting | Markov chain model |
| | | Regression | Linear regression |
| | Market basket | Association | Association rules |
| | analysis | | Markov chain model |
| | | Sequence | Association rules |
| | | discovery | |
| | Up/cross selling | Association | Association rules |
| | | | Neural network |
| | | Sequence | Mixture transition distribution |
| | | discovery | |

In the context of analytical CRM, the expert system 11 may build a model from data (step 310 of FIG. 3 or FIG. 5). For example, a model can be used to increase the response rates of a marketing campaign by segmenting customers into groups with different characteristics and needs, or to predict how likely an existing customer is to take her business to a competitor.

Each CRM element can be supported by different CRM models, for example, association, classification, clustering, forecasting, regression, sequence discovery, and visualization.

There are numerous machine-learning techniques available for each type of CRM model. The expert system 11 may choose algorithms using methods knowledge base 42 based on data characteristics and business requirements as determined in stages 100 and 200 of the process shown in FIG. 3. Exemplary algorithms include association rule, decision tree, genetic algorithm, neural networks, K-Nearest neighbor, and linear/logistic regression, as outlined below.

CRM Models

(1) Association

Association aims at establishing relationships between items that exist together in a given record. For example, the inference engine 18 of expert system 11 may recommend association modeling for market basket analysis and cross selling programs. It may also recommend tools such as statistics and a priori algorithms.

(2) Classification

Classification aims at building a model to predict future customer behaviors through classifying database records into a number of predefined classes based on certain criteria. For classification, the inference engine 18 may recommend tools such as neural networks, decision trees, and if then-else rules.

(3) Clustering

Clustering is the task of segmenting a heterogeneous population into a number of more homogenous clusters. It is different from classification in that clusters are unknown at the time the algorithm starts, i.e. there are no predefined clusters. For clustering, the inference engine 18 may recommend tools such as neural networks and discriminant analysis.

(4) Forecasting

Forecasting estimates a future value based on a record's patterns. It relates to modeling and the logical relationships of the model at some time in the future; demand forecast is a typical example of a forecasting model. The inference engine 18 may recommend tools such as neural networks and survival analysis for forecasting.

(5) Regression

Regression is a statistical technique used to estimate relationships among variables, and to provide a prediction value. Uses of regression include curve fitting, prediction (including forecasting), modeling of causal relationships, and testing hypotheses about relationships between variables. For regression, the inference engine 18 may recommend tools such as linear regression and logistic regression.

(6) Sequence Discovery

Sequence discovery is the identification of associations or patterns over time. The goal is to model the states of the process generating a sequence, or to extract and report deviation and trends over time. The inference engine 18 may recommend tools such as statistics and set theory for sequence discovery.

(7) Visualization

Visualization refers to the presentation of data so that the retail business user can view complex patterns and reach a better understanding of the data; using variations of color dimensions, and depth, visualization may lead to find new associations. It is used in conjunction with other CRM models to provide a clearer understanding of the discovered patterns or relationships.

Algorithms

The following algorithms may be provided by methods knowledge base 42 and/or CRM knowledge base 44.

(1) Association Rule

Association rule finds interesting correlation relationships among a large set of data items. A typical application would be market basket analysis, which analyzes customers' buying habits by finding associations between the different items that customers place in their shopping baskets.

(2) Decision Tree

Decision trees try to uncover associations in the data. They search for similarities within existing records and try to infer the rules that express those relationships. Decision trees are flow charts—tree structures in which nodes represent tests or attributes, branches represent test outcomes, and leaf nodes represent classes or class distributions with similar characteristics.

(3) Genetic Algorithm

Evolution and natural selection have over the course of time resulted in adaptable and specialized species that are highly suited to their environments, and genetic algorithms are problem-solving techniques inspired by biological processes. The algorithms are based on the idea of using several simple agents to do something complex, the same way seemingly simple creatures like ants cooperate to solve the complex problem of finding the most efficient route to a source of food.

(4) Neural Networks

Neural networks are a class of flexible and general-purpose algorithms readily applied to prediction, estimation, and classification problems. The first artificial neural networks were attempts to simulate the workings of biological neural networks using digital computers. When used in well-defined domains, their ability to learn and generalize from data mimics, in some sense, the human ability to learn from experience. Neural networks can analyze imprecise, incomplete, and complex information, and find important patterns from this information, patterns generally so complicated that they are not easily detected by humans or by other types of computer-based analysis.

(5) K-Nearest Neighbor

Nearest-neighbor algorithms are based on the concept of similarity. They are examples of instance-based learning, in which using a training data set, classification for a new unclassified record may be possible simply by comparing it to the most similar records in the training set. In the memory-based reasoning approach, results are based on analogous situations in the past. In the collaborative filtering approach, the algorithms go beyond just using similarities among neighbors, and also add more information such as their preferences (e.g. in order to make a recommendation).

(6) Linear/Logistic Regression

Regression in its simplest form is the process of using the value of a variable in order to predict the value of a second one. The most common form of regression is linear regression, so called because it attempts to fit a straight line through the observed X and Y pairs of variables in a sample. After the line has been established, it can be used to predict a value for Y given any X. A linear regression model is one of the natural choices (with, for example, neural networks) when the task is to estimate the value of a continuous target, whereas logistic regression is primarily used for predicting binary variables.

CRM System

In some embodiments, the present invention may provide a data platform in the form of a packaged solution that offers preselected variables and factors for CRM business objectives in the retail sector. The data platform may be used to acquire at least some of the data in step 230 of FIG. 3 and FIG. 5, for example.

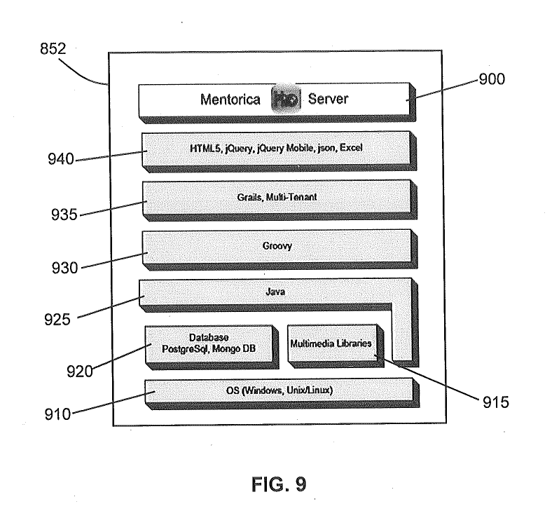

The data platform, as exemplified by CRM system 810 shown in FIG. 8, is characterized by an easy-to-use interface, whose objective is to shunt, as much as possible, the laborious process of data acquisition, data cleaning, data selection, etc., for the business user. The system 810 may save the retailer a lot of time and ingenuity in the identification of the most significant variables as it avoids having to reinvent the wheel; it also minimizes the need for human experts with up-to-date know-how.

The system 810 allows collection of a retailer's internal data, the information about its activity and operating environment. The system 810 may also allow enrichment of data, to create better models, by making available and fusing together various sources of information, internal and external data:

Referring to FIG. 8, there is shown a CRM system 810 which comprises a retail network management system 850 of a retail organisation. The retail management system 850 may be located on-site within the retail organization, or may comprise a plurality of components (web servers, database servers, storage devices) distributed across a plurality of locations, with the plurality of components being networked so as to be in communication with each other, either directly, or indirectly through one or more central servers. In general, the retail management system 850 performs resource-intensive back end functions such as storage, data management, and analytics, while front end devices 820, 822, 824 operated by users provide an application interface which provides users with access to data and services of the back end.

In certain embodiments, the system 810 may have functionality for generating and applying one or more models to data acquired by the system. For example, the retail network management system 850 may comprise an expert system 11 as described above. The expert system 11 determines, based on user input, the analysis objectives, applies preprocessing 200 to the raw input data acquired by system 810 to obtain processed input data, generates and validates 300 one or more models, and applies 400 the model(s) to the processed input data to produce numerical and graphical output which is displayable on a display 822 of a device of a user 832.

The CRM system 810 may also comprise customer mobile devices (not shown) each executing a mobile application for interacting with retail management network 850 in order to obtain a restricted subset of information, for example product catalogue information, and to input data relating to survey responses, which is then stored in database 862 (for example, via upload to web server 852) of the retail management network 850 for analysis, as will later be described.

The retail management system 850 communicates with a plurality of sales force devices 822 (only one of which is shown for clarity) associated with the retail organization, and at least one, and preferably more than one, manager device 824 of the system 810. The manager device 824 provides higher-level access to functions of the CRM system 810 relative to the sales force devices 822. Each sales force device 822 is associated with a salesperson, and may provide an application interface which enables the salesperson to obtain inventory data, product information, customer data and so on from the retail network management system 850. Each manager device 824 may be provided with additional functionality or data which is not available to the sales force devices 822, such as information regarding individual salesperson performance.

The sales force devices 822 connect to and communicate with the management system 850 via a mobile data network 834 which is in communication with a mobile gateway system 842. The mobile gateway system 842 connects to a server of the management system 850 via a firewall 844. Similarly, the manager devices 824 connect to and communicate with the management system 850 via a communications network such as the Internet 832 and firewall 844.

Data from the sales force devices 822 and manager device 824 is received by a web server 852 which may then communicate the received data, or processed data derived from it, to one or more data analytics servers 854, 856. The data analytics servers 854, 856 are each in communication with data stores 862, 864 which store records in relation to products, physical stores (with inventory information being derivable from an association between the products and the stores), sales, customer feedback and customer demographics, and manufacturers and designers of the products.

Data analytics servers 854, 856 retrieve records from the data stores 862, 864, for example in relation to historical customer interaction data indicating customer feedback in relation to a product and/or product sales, and process the retrieved data in response to requests received from devices 822, 824 to determine various parameters useful to the users of devices 822, 824.

The CRM system 810 enables the real-time acquisition and analysis of appropriate data (for example, sales and customer feedback data) for the purpose of addressing business objectives of the retail organization. With respect to data, business users must evaluate which factors, and therefore which sources, are necessary for a given business objective. For example, if the general business objective (analysis goal) is to reduce customer attrition and churn (i.e. loss of clients to the competition), a factor related to customer satisfaction may be needed that is not currently in the retailer database 862. Therefore, in order to obtain this data, the retailer might typically design a questionnaire and launch a survey for its current customers. The results of defining and identifying new factors may require a search for the corresponding data sources, if available, and/or obtain the data via surveys, questionnaires, new data capture processes, etc. Demographic data about specific customers can be elicited from them by using the surveys, questionnaires and loyalty registration forms.

The following aspects of the system 810 help to ensure that all elemental data and acquisition processes necessary to create a data model are available to the system 810.

A sales force CRM application, executable by sales force device 822, structures and collects internal engagement data relating to a retailer's products, customers' demographic data, customers' transactional data, as well as hard-to-get feedback on customers' preferences which retailers otherwise commonly attempt to obtain from surveys and questionnaires. The acquired internal engagement data may be uploaded by sales force device 822 to web server 852, for example.

A customer loyalty CRM application executable on a customer's device allows a retailer to collect and accumulate (via web server 852 interacting with the customer device) internal customer data—demographic and transactional—and make possible specific commercial actions based on detected customer profiles. For example, the derived information can be used to potentiate sales of specific products, cross-sell products, and develop customer loyalty campaigns.

A data integration application executable on, for example, an analytics server 854 or 856 of retail management network 850, offers access to external data, which may affect a retailer and its customers in various ways; data such as demographic and census data, macro-economic data, transportation data, roaming data. More datasets can be loaded by the data integration application in the platform when they become available, and if it is determined that they are relevant to retailers' CRM business objectives.

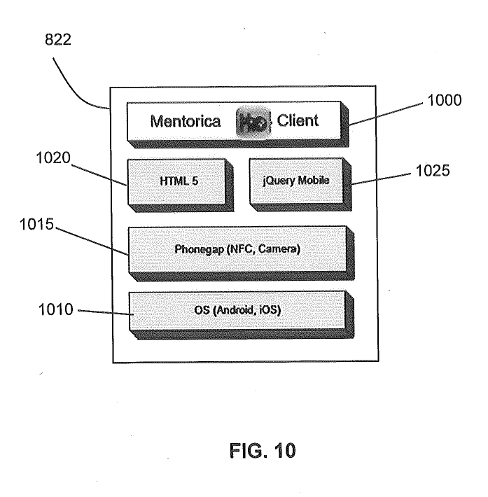

An exemplary web server 852 is illustrated in schematic form in FIG. 9. The web server 852 has stored on non-volatile storage thereof a plurality of software modules for performing a variety of functions. The software modules comprise an operating system 910, such as Microsoft Windows or Linux; a database management system 920, such as PostgreSql or Mongo DB; multimedia libraries 915 for handling multimedia content to be served by the server 852; Java class libraries 925; Groovy libraries 930; a web application framework such as Grails 935, preferably including a multi-tenant plugin; and libraries 940 for handling HTML5, jQuery, jQuery mobile, json and Excel. Interacting with these software modules is a server module 900 which serves pages to the sales force CRM and customer loyalty CRM applications.

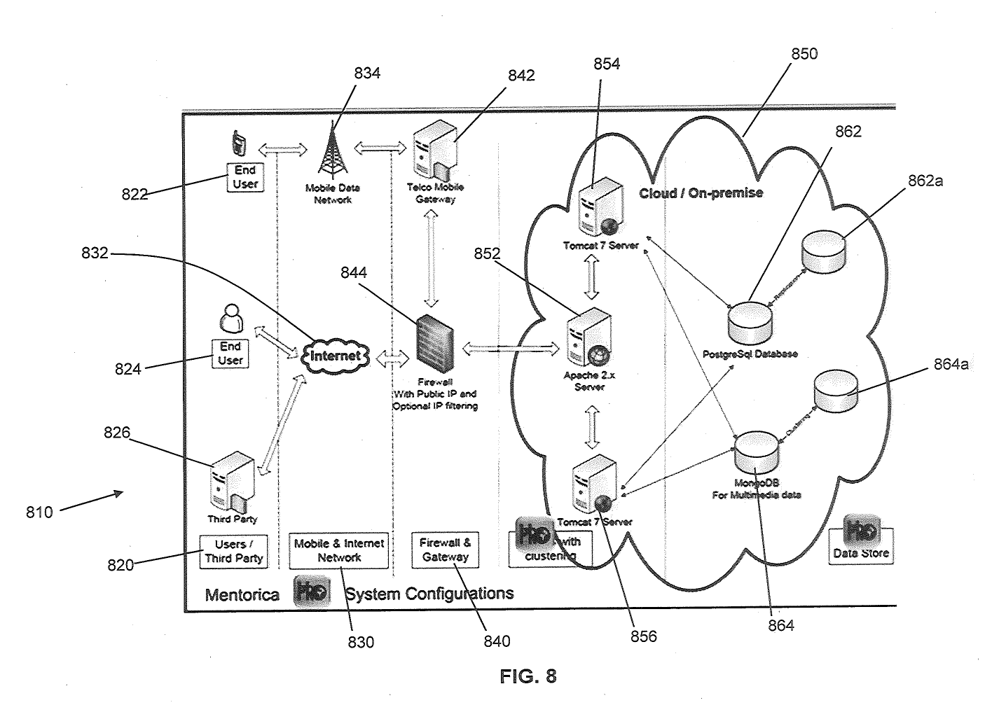

FIG. 7 gives examples of which data sources are relevant for which CRM business objectives, and it especially shows how the internal engagement data and the customer loyalty CRM application completely map all the CRM dimensions. A retailer's products, customers, and transactions are the primary data sources, and a modeling project can be considered that uses only this elemental data and no other sources. These primary data sources are indicated in the figure header labeled “Internal”.

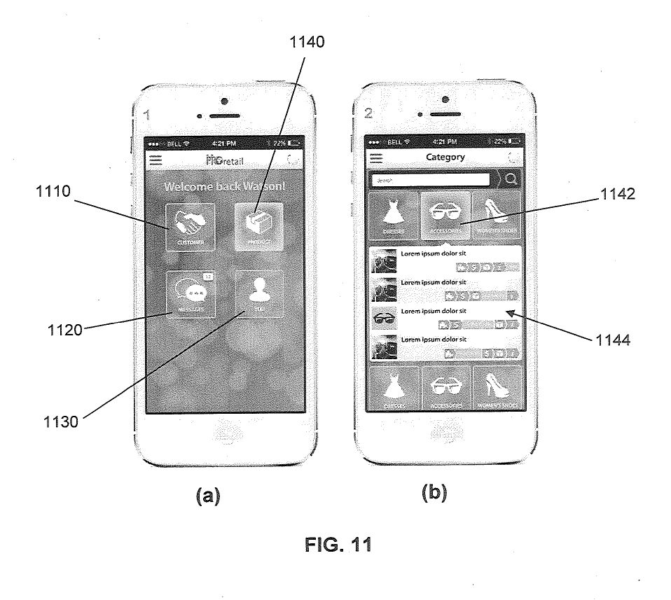

An exemplary sales force device 822 running the sales force CRM application 1000 is shown in FIG. 10. In addition to the sales force CRM module 1000, the sales force device 822 has stored on non-volatile storage thereof an HTML5 module 1020, a jQuery mobile module 1025, Phonegap libraries 1015, and an operating system 1010 such as Android or iOS.

In order to explore and model its business data, a retailer needs a good classification system, with subgroupings where necessary, of its products and sales channels.

The data available about a retailer's products depends on the type of business activity and sector the business is in. Typically, a retailer's products can be classified into categories such as dresses, women's shoes, accessories, etc. For each group of products, the characteristics of the products are defined by attributes such as color, sizes, etc. Also, an adequate classification for the retailer's commercial structure, by sales channels, regional branches, etc., is important.

The sales force CRM application 1000 allows the complete mapping of each retailer's product categories and attributes, and sales channels. This information is extracted from the retailer's inventory system by using an Inventory Application Programming Interface (API), and automatically formatted by the sales force CRM application 1000 for import into an internal retail data database.

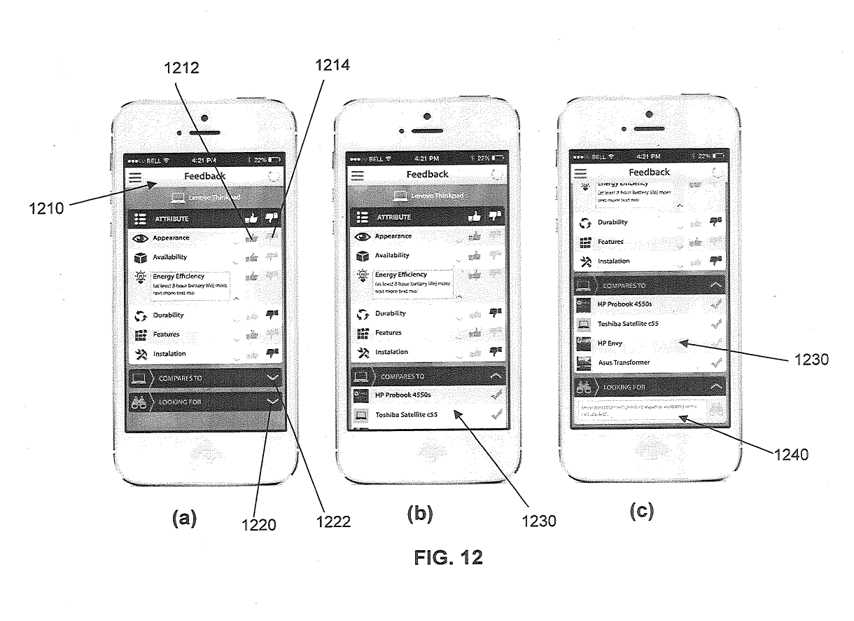

FIG. 11 and FIG. 12 show screen shots of the sales force CRM application 1000. In FIG. 11(a) the user is presented with four buttons to access various functions implemented by the application 1000: a customer button 1110, a messages button 1120 for accessing messages from other salespersons and/or management staff, a user profile button 1130, and a product button 1140. On pressing product button 1140, product categories 1142 and attributes 1144 are made visible on the display.

On selection of a particular product from amongst the product categories 1142, a feedback interface 1210 may be presented to the user, as shown in FIG. 12(a). The feedback interface 1210 provides an electronically fillable form for capturing customer feedback in structured format.

Surveys and questionnaires are mainstays of marketing; they allow for feedback from actual and potential customers, and can give a retailer a feel for current trends and needs. With this information, a retailer can create profiles of customers so that it knows them better, can sell them more products, and can give greater customer satisfaction by providing more personalized attention.

For example, with surveys, a retailer may be planning a new marketing campaign and the questionnaire it used in the past did not elicit the appropriate responses, or the retailer needs to obtain variables that it does not currently have, ones that are highly relevant for a particular business objective.

Unfortunately, more often than not, in-store customer surveys are voluntary filled by customers and are offered on paper, a state of affairs which does not facilitate data availability, and does not control the quality of the input for subsequent data processing.

However, once a retailer and its salespeople begin using the sales force CRM application 1000, it accumulates and transmits to retail network management system 850, in real time, high quality data about customer engagements—such as point of engagement (e.g. store type, geographic location), day, time, sales information if any, customer feedback, customer demographics, etc., and customer identification if the customer's mobile device has the customer loyalty CRM application executing thereon. A significant history of customer engagements, sales transactions, and data will be accumulated after just a few months' worth of use of the sales force CRM application 1000.

For example, customer feedback forms generated by sales force CRM application 1000 may be:
Designed to obtain market information in order to improve targeting potential clients, i.e. towards satisfying the business objective of augmenting the rate of conversion of potential clients to clients,
Targeted at current clients to obtain additional information for the business objective of cross-selling a retailer's products,
Designed to obtain the reasons why some clients stop buying, or do not buy, a retailer's products, i.e. toward satisfying the business objective of using this information to take a priori action to reduce customer attrition and churn.

Also, by the very nature of using the sales force CRM application 1000 rather than using a paper survey, the retailer is able to control data input and capture consistent data. The application's feedback forms acquire data in structured format, guaranteeing data quality, which includes controlling the consistency of the data format and types, and ensuring that all the information variables included are relevant to any CRM business objective. The system improves data input quality by obliging the salesperson to enter information on the preselected product categories, and by using free text fields only to provide additional context on a particular feedback.

FIG. 12 shows real-time feedback capture screens of sales force CRM application 1000. In FIG. 12(a) the feedback form 1210 displays a plurality of feedback categories, each with “thumbs up” 1212 and “thumbs down” 1214 buttons associated therewith, for providing a convenient means for a user of the sales force application 1000 to enter the customer's feedback. More sophisticated ratings input mechanisms can be used, for example by having more than two possible ratings, or providing a slider control for selecting a value between lower and upper ratings limits. The feedback form 1210 may comprise means for entering other types of feedback, for example by providing a control 1222 to expand a list 1230 of other products in the category, which can be selected to indicate that the customer is seeking to compare the product to, or is also interested in, the other selected products. Control 1220 expands a text entry area 1240 which can be used to enter other feedback which does not fit the structure provided by the other parts of feedback form 1210.

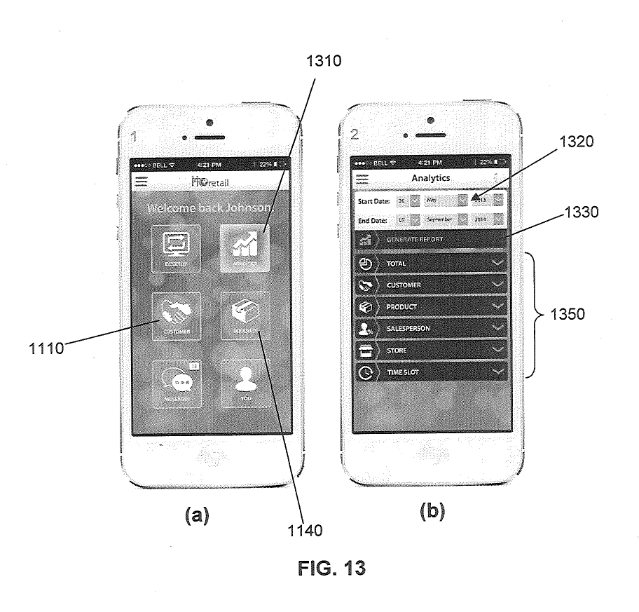

In some embodiments, the sales force CRM application 1000 may provide different levels of access to different users. For example, the application interface shown in FIGS. 11 and 12 may be provided to salesperson users, while an enhanced interface, shown in FIG. 13, may be provided to management users. The enhanced interface may display, as well as the buttons 1110, 1140 etc. provided to salesperson users, additional buttons providing access to enhanced functionality such as reporting and analytics. In FIG. 13(a), pressing an analytics button 1310 causes the interface to display a reporting screen, shown in FIG. 13(b). The reporting screen may provide a menu for generating reports relating to a range of variables 1350, including total sales (possibly stratified by geographical region or other variables), customer variables (based on demographic data, for example), product variables (e.g., product category or specific product), salesperson, store, and time slot. The interface may comprise a date range selection dialogue 1320. On pressing “generate report” button 1330, the sales force CRM application 1000 is caused to query the internal engagement data database using the selected variable(s), and to perform one or more analysis functions on the retrieved data, for example summarisation and visualisation.

From the elemental internal engagement data, the sales force application 1000, without any modeling from the business user, can already produce powerful internal retail data reporting, with real-time business reports that include summaries and details of sales by period, geographical area, sales channel, product categories, etc. From this data the retailer can for example deduce, by simple inspection, that one product line sells best in a particular store. The company can also for instance identify salespeople that sell above or below the average for a given period, which can indicate where corrective action is needed or success should be praised.

In addition to implementation on a mobile device, the sales force application 1000 may also, of course, be implemented on a desktop computing device 826.

Customer Loyalty CRM Application

A customer loyalty CRM application may execute on a customer's device.

From the point of view of a retailer, the main purpose of the customer loyalty CRM application is to allow knowing more about its customers through the accumulation of data about them, and making possible specific commercial actions based on detected customer profiles. In terms of CRM business objectives, the derived information can be used to potentiate sales of specific products, cross-sell products, or develop customer loyalty campaigns.

The customer loyalty application is designed to gather the most reliable and relevant data to support it. In the program registration phase, the customer loyalty application asks the customer key questions to obtain basic contact information and data that is highly relevant to the CRM dimensions and business objectives of the specific retailer; demographic information will be used for targeting specific products and eventually increase for example the conversion rate of customer engagement to product sales, specific information for segmenting customers and evaluating the effectiveness of sales channels will be collected, product-specific data can be gathered for customer profiling, together with information about the competition, which can be used to improve market awareness.

Just like with the sales force CRM application, the use of a digital application over a paper form greatly enhances the reliability of the data obtained. Also, similarly, data based on categories and limited multiple choice options over free text fields is privileged whenever possible; indeed, from a data quality point of view, categorized data is easier to control, whereas free text fields may need additional post-processing, given that data may be entered inconsistently by customers (e.g. address fields).

Another key aspect of the customer loyalty application is the customer's use of the application itself. As the customer “checks in” the retailer's stores and uses the application, a log is generated of the products purchased, the date and time, the amount of money spent, the location of the store, etc. (and this data is potentially further completed by what the salesperson captures on the sales force application during that particular customer engagement). In combination with internal engagement data, this data is key as customers are otherwise completely anonymous.

Once transactional data is accumulated, a transactional profile is created. The transactional profile is then related with the customer's demographic profile and personal data, which was captured during the registration process.

In terms of CRM business objectives, this information can be used, for example, to adjust a store layout, product placement, and product mix based on the detected tendencies and preferences of the customers. Also, specific types of customers can be sent customer loyalty notifications or mailings with promotions of products related to what they have bought in the past.

The customer loyalty application also enables acquiring real-time customer feedback with the aim of measuring customer experience and improving customer satisfaction.

After the customer has left the store, i.e. after enough time after the customer digital check-in, a “non-buyer” short digital survey, comprising an electronically fillable form displayable in the customer loyalty application, can be sent to mobile devices of customers who left without making a purchase, to understand the purpose of their visit and what prevented them from making a purchase on that occasion. Whereas for customers who purchased something, feedback can be captured on the products bought and their categories on screens of the customer loyalty application similar to those of the sales force CRM application 1000.

1. A computer-implemented method for generating a user interface to a data analysis engine comprising a plurality of analysis tools, the method comprising:
providing: a methods knowledge base comprising rules which map data types and/or analysis goals to analysis tools; an inference engine; and a user interface module;
receiving, by the user interface module, input relating to one or more user-defined analysis goals;
determining, by the inference engine, one or more required data sets based on the one or more user-defined analysis goals;
determining, by the inference engine using the methods knowledge base, one or more recommended analysis tools based on the one or more user-defined analysis goals and the one or more required data sets; and
outputting, to the user interface module, a control component for each of the one or more recommended analysis tools, each control component being configured to, on detection of a user input event, execute the respective analysis tool on at least one of the required data sets.

2. The computer-implemented method according to claim 1, further comprising determining the availability of the required data sets.

3. The computer-implemented method according to claim 2, further comprising, if a required data set is unavailable, generating the required data set using an electronic survey or an electronic questionnaire.

4. The computer-implemented method according to claim 1, wherein the analysis tools are selected from the group consisting of: summarization tools; segmentation tools; concept description tools; classification tools; prediction tools; and dependency analysis tools.

5. The computer-implemented method according to claim 1, wherein the methods knowledge base relates to analytical customer relationship management.

6. The computer-implemented method according to claim 1, wherein the one or more required data sets relate to one or more of: customer feedback data, sales data, inventory data, product characteristics, demographic data, and geographic data.

7. The computer-implemented method according to claim 1, wherein at least one of the analysis tools is a segmentation model or a predictive model.

8. The computer-implemented method according to claim 7, further comprising determining, by the inference engine, whether respective analysis goals are quantitative or qualitative; and based on said determination, activating, from the methods knowledge base, rules relating to selection of models and/or data preparation tools from said analysis tools.

9. The computer-implemented method of claim 1, further comprising updating one or more of the required data sets using a real-time stream of additional data.

10. The computer-implemented method according to claim 9, further comprising recalibrating the predictive model with the updated one or more required data sets.

11. The computer-implemented method of claim 1, further comprising determining, by the inference engine, a data type of one or more of the required data sets; and based on said determination, activating, from the methods knowledge base, rules relating to selection of models and/or data preparation tools from said analysis tools.

12. The computer-implemented method according to claim 1, further comprising determining the coverage and/or quality and/or relevance of the one or more required data sets.

13. The computer-implemented method according to claim 12, further comprising generating additional data to fill missing values in a variable of the one or more data sets.

14. The computer-implemented method according to claim 13, wherein the additional data are generated by one or more of: computing an average value of the available data; determining gaps in a distribution of the available data, and interpolating to fill the gaps; and generating a predictive model using a further variable which is correlated with said variable.

15. The computer-implemented method according to claim 1, further comprising performing a goal-driven or data-driven variable selection process on the one or more required data sets.

16. A system for generating a user interface to a data analysis engine comprising a plurality of analysis tools, the system comprising:
a methods knowledge base comprising rules which map data types and/or analysis goals to analysis tools;
an inference engine; and
a user interface module;
wherein the user interface module is configured to receive input relating to one or more user-defined analysis goals;
wherein the inference engine is configured to:
determine one or more required data sets based on the one or more user-defined analysis goals; and
determine, using the methods knowledge base, one or more recommended analysis tools based on the one or more user-defined analysis goals and the one or more required data sets; and
wherein the user interface module is configured to output a control component for each of the one or more recommended analysis tools, each control component being configured to, on detection of a user input event, execute the respective analysis tool on at least one of the required data sets.

17. A customer relationships management system for a retail organization, comprising:
a server;
a data store in communication with the server, the data store comprising a plurality of records representing products offered for sale within the retail organization and sales outlets within the retail organization;
a plurality of client devices configured to communicate with the server, the client devices including a plurality of sales force devices and at least one manager device;
wherein the server is configured to:
receive customer engagement data from the sales force devices, the customer engagement data indicating a product sale event and/or customer feedback on a product; and
process the customer engagement data to determine one or more of: inventory status for the product; customer preferences in relation to the product; and predicted customer purchasing behavior.

18. A computer-implemented method for acquiring real-time customer feedback in a retail environment, the method comprising:
retrieving product data indicative of categorized product information from a retail inventory system;
generating, based on the categorized product information, a user interface configured to display user-selectable product categories and products;
for each said product, configuring the user interface to display an electronically fillable feedback form, the electronically fillable feedback form being configured to receive user input relating to a plurality of feedback fields; and
receiving, in the electronically fillable feedback form, user input relating to the plurality of feedback fields to generate structured customer engagement data.

19. The method according to claim 18, further comprising: receiving customer demographic data; and associating the customer demographic data with the structured customer engagement data.
